(19) United States
(12) Patent Application Publication
(10) Pub. No.: US 2022/0035367 A1
(43) Pub. Date: Feb. 3, 2022

(54) COORDINATION OF REMOTE VEHICLES USING AUTOMATION LEVEL ASSIGNMENTS

(71) Applicant: Human Automation Teaming Solutions, Inc., Canoga Park, CA (US)

(72) Inventors: Nhut Ho, Canoga Park, CA (US); Walter Johnson, Canoga Park, CA (US); Kenneth Wakeland, Canoga Park, CA (US); Kevin Keyser, Canoga Park, CA (US); Karanvir Panesar, Canoga Park, CA (US); Garrett Sadler, Canoga Park, CA (US); Nathaniel Wilson, Canoga Park, CA (US)

(21) Appl. No.: 17/275,183

(22) PCT Filed: Sep. 12, 2019
(86) PCT No.: PCT/US2019/050797

§ 371 Date: Mar. 10, 2021

Related U.S. Application Data
(60) Provisional application No. 62/731,594, filed on Sep. 14, 2018.

(51) Int. Cl. G05D 1/00; G05D 1/10; B64C 39/02; G08G 5/00

(52) U.S. Cl. CPC G05D 1/0027; G05D 1/104; B64C 39/024; B64C 2201/14; G08G 5/0043; G08G 5/0069; G08G 5/0013

(57) ABSTRACT

Systems and methods here may include computing system configured to coordinate more than one remotely operated vehicle using level of automation determination and assignments. In some examples, the method for coordinating a plurality of drones includes using a computer with a processor and a memory in communication with the plurality of drones, and a candidate problem resolver for retrieving a candidate resolution from a data storage, and sending the retrieved candidate resolution to a candidate resolution states predictor.

### CROSS REFERENCE

This application relates to and claims priority to U.S. Provisional Application 62/731,594 filed Sep. 14, 2018, the entirety of which is hereby incorporated by reference.

### TECHNICAL FIELD

This application relates to the field of remote operation of vehicles, networking, wireless communications, sensors, and automation of such including using machine learning.

### BACKGROUND

Although remote operated vehicles exist today, the coordination and networking of those vehicles is lacking. Because of this, inefficient one-to-one ratios of human pilots to drones are needed to accurately control each one separately. This includes flying, roving, and/or water drone vehicles.

There needs to exist a technological solution to coordinate and operate more than one remotely operable vehicle.

Automation is being designed so that it can handle more and more problems or tasks autonomously, that is without help or supervision from humans. This is beneficial because it can free up the human for other tasks or decrease the number of humans needed to operate the automation. However, in many applications this automation results in unsafe, costly, or otherwise undesirable solutions. As a result, the humans must continually supervise the automation, and forego the benefits that come with autonomous automation. Currently the basis for allocation of autonomy in automated systems is either 1) not dynamic (inflexible), relying on assigning the level of autonomy on the predefined nature of the task to be done, but not requiring human supervision (low workload) or 2) is dynamic (flexible), but requires the human operator to supervise the system and change the level of autonomy assigned to a task (high workload). Current allocation systems either depend on continuous supervision, thus adding workload and decreasing the overall value of the system or depend on a system that can be wholly trusted to get the allocation answer correct, which is very difficult to ensure. These methods add workload to supervise the system and adjust autonomy that was not present in a system that had no autonomy. Thus, where the goal of having autonomous capabilities is to relieve the human of work, these savings are offset by the need to supervise the allocation of responsibility between human and automation.

### SUMMARY

Systems and methods here may include computing system configured to coordinate more than one remotely operated vehicle using level of automation determination and assignments. In some examples, the method for coordinating a plurality of drones includes using a computer with a processor and a memory in communication with the plurality of drones, and a candidate problem resolver for retrieving a candidate resolution from a data storage, and sending the retrieved candidate resolution to a candidate resolution states predictor. In some examples, the candidate resolution states predictor, may be used for generating predicted candidate resolution states, based on the determining a level of autonomy governing the process of presentation for each candidate resolution, selecting a top candidate resolution to execute from a plurality of candidate resolutions, determining the level of autonomy for the top candidate resolution, and if the determined level of autonomy for the top candidate is autonomous, then sending commands to each of the plurality of drones.

Methods here include coordinating a plurality of remote drones, at a computer with a processor and a memory in communication with the remote drones, the method including analyzing input data to determine a system state of the plurality of drones, at a system state monitor, sending system state variables to a problem detector, wherein a problem is a variable outside a predetermined threshold, if a new problem is detected by the problem detector, determining candidate resolutions at a candidate problem resolver using problem threshold data, determining a level of automation for each of the determined candidate resolutions, wherein the levels of automation are one of autonomous, veto, select, and manual, sending resolutions and associated level of automation assignments for each of the remote drones to a resolution recommender, and if the level of automation is autonomous, sending a top resolution as a command to each of the plurality of drones.

Example methods include, if the level of autonomy is veto, sending commands to each of the plurality of drones unless a veto is received from the user. In some examples, if the level of autonomy is select, sending manual selections for the user to select, receiving one of the manual selections, and sending the received manual selection to each of the plurality of drones. In some examples, if the level of autonomy is manual, waiting to receive manual input from the user, receiving a manual input, and sending the received manual input to each of the plurality of drones.

Some example methods include coordinating a plurality of drones, including by a computer with a processor and a memory in communication with the plurality of drones, by a candidate problem resolver, retrieving a candidate resolution from a data storage, and sending the retrieved candidate resolution to a candidate resolution states predictor, by the candidate resolution states predictor, generating predicted candidate resolution states, based on the retrieved candidate resolution, determining a level of autonomy governing the process of presentation for each candidate resolution, selecting a top candidate resolution to execute from the a plurality of candidate resolutions, determining the level of autonomy for the top candidate resolution, and if the determined level of autonomy for the top candidate is autonomous, sending commands to each of the plurality of drones. In some embodiments, if the level of autonomy is veto, sending commands to each of the plurality of drones unless a veto is received from the user. In some embodiments, if the level of autonomy is select, sending manual selections for the user to select, receiving one of the manual selections, and sending the received manual selection to each of the plurality of drones. In some embodiments, if the level of autonomy is manual, waiting to receive manual input from the user, receiving a manual input, and sending the received manual input to each of the plurality of drones.

Some embodiments include an asynchronous problem resolver resolution manager configured to receive candidate resolutions with assigned levels of autonomy from an asynchronous problem resolver level of autonomy selector, and determining at least one of the following for the received candidate resolutions: identifying candidate resolutions sharing highest level of autonomy, breaking a tie, causing display of ordered recommendation list, causing display of a top candidate, sending a message for display to an operator that no acceptable candidate found by automation, and autonomously executing the top candidate.

Some embodiments include receiving a play from the user, wherein a play allows a user to select, configure, tune, and confirm. In some embodiments, select includes filter, search, and choose a play from a playlist. In some examples, configure includes adding or removing assets and modifying thresholds. In some examples, tune includes reviewing the play checklist, and changing the corresponding level of autonomy. In some examples, confirm includes projecting actions that will occur after the play is initialized. In some examples, a play is defined in terms of nodes, which correspond to inputs, tasks, and subplays. The node graphs, which connect nodes, purport to achieve the goal of a play.

### BRIEF DESCRIPTION OF THE DRAWINGS

FIG. 1 is a high-level network diagram of assets which may be employed according to embodiments disclosed herein.

FIG. 2 is an example flow chart of high-level architecture which may be employed according to embodiments disclosed herein.

FIG. 3-5 are more detailed example flow charts which may be employed according to embodiments disclosed herein.

FIG. 6 shows an example PLAYS flow chart according to embodiments described herein.

FIG. 7 is a network diagram of assets which may be employed according to embodiments disclosed herein.

FIG. 8 is an example computer embodiment which may be used with any of the various embodiments disclosed herein.

FIG. 9-17 are screenshots of example graphical user interfaces according to embodiments disclosed herein.

FIG. 18 is an example computer display example showing example arrangements of user interfaces according to embodiments disclosed herein.

FIG. 19-21 are screenshots of example graphical user interfaces according to embodiments disclosed herein.

### DETAILED DESCRIPTION

Reference will now be made in detail to embodiments, examples of which are illustrated in the accompanying drawings. In the following detailed description, numerous specific details are set forth in order to provide a sufficient understanding of the subject matter presented herein. But it will be apparent to one of ordinary skill in the art that the subject matter may be practiced without these specific details. Moreover, the particular embodiments described herein are provided by way of example and should not be used to limit the scope of the invention to these particular embodiments. In other instances, well-known data structures, timing protocols, software operations, procedures, and components have not been described in detail so as not to unnecessarily obscure aspects of the embodiments of the invention.

Overview

Systems and methods here provide for computer networks and solutions to coordinate multiple remotely operable vehicles to efficiently task and run them by less than a one-to-one human operator to vehicle ratio. The usage of these drone fleets may allow for augmenting a human team with machine drones to collect data in a non-stop tempo, unachievable with human operators alone.

The usage of these drones in more than one fleet, may allow an enterprise to more efficiently accomplish a long distance, and/or widespread or complex task. That is, multiple drones may have the capability of covering large territory, and thereby more effectively covering any given area. Examples include monitoring an area of land or water for extended periods. Monitoring may include any number of things such as but not limited to taking sensor data on heat, movement, gas leakage, water, precipitation, wind, and/or fire.

It should be noted that the terms drone, remote vehicle, vehicle, or any similar term is not intended to be limiting and could include any kind of machine capable of movement and remote operation. Such remotely operable vehicles, sometimes referred to as drones, or remote vehicles, may be any kind of vehicle such as but not limited to flying drones such as but not limited to helicopter, multi-copter, winged, lighter-than-air, rocket, satellite, propeller, jet propelled, and/or any other kind of flying drone alone or in combination. Drones may be roving or land based such as but not limited to wheeled, tracked, hovercraft, rolling, and/or any other kind of land based movement, either alone or in combination. Drones may be water based such as but not limited to surface craft, submarine, hovercraft, and/or any combination of these or other watercraft. Drones may have multiple modes of transportation, such as being able to convert from one mode to another, such as a flying drone with wheels. Drones may be equipped with modular features that allow changes between modes, such as adding floats to a flying vehicle. Any combination of any of these drone features could be used in the systems and methods described herein. The use of examples of certain drones with or without certain capabilities is not intended to be limiting.

Examples of sensors which may be attached to and operated on these remove vehicles could be any kind of sensor, such as but not limited to gas sniffers, visible light cameras, thermal cameras, gyroscopes, anemometer, thermometer, seismometer, and/or any combination of these or other sensors.

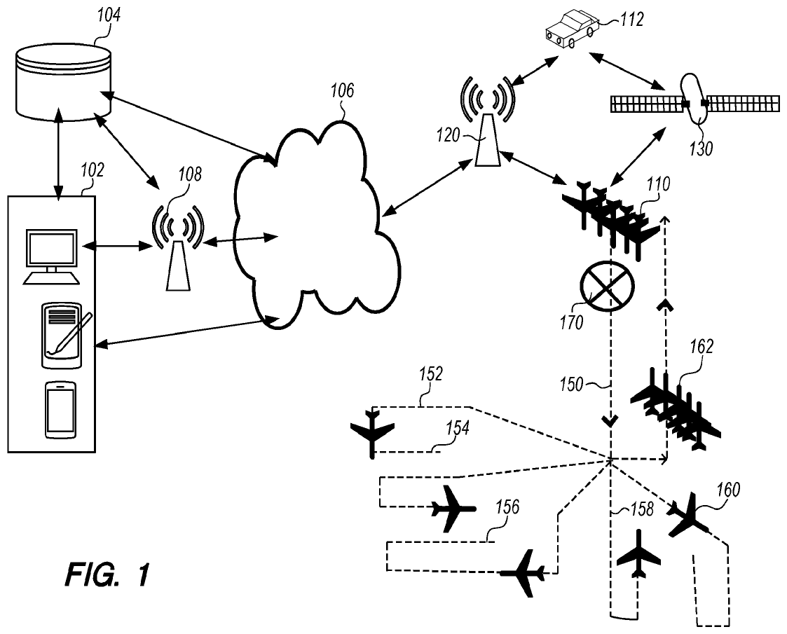

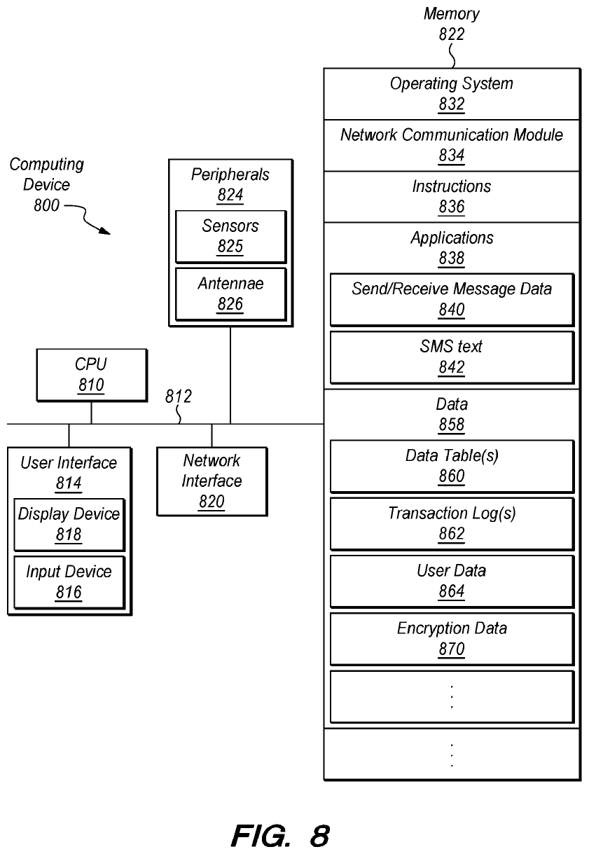

An example network arrangement of such a drone operation is shown in FIG. 1. In FIG. 1, a back end computing system 102 such as a server, multiple servers, computers with processors and memories as described in FIG. 8, in communication with a database 104 and a network 106. In some examples, the computing system 102 could be a handheld or mobile device such as a smartphone, tablet, or wearable device such as smart watch, glasses, virtual reality headset, and augmented reality headset with camera arrangement. It could be a combination of handheld and desktop devices, or any combination of the above or other computing devices. By these computing devices 102, the steps and methods are accomplished to communicate with, coordinate, instruct, and otherwise operate the remote systems as described herein.

The example network 106 could be the Internet, a proprietary network, or any other kind of communication network. In some examples, the computing system 102 communicates through a wireless system 108 which could be any number of systems including but not limited to a cellular system, Wi-Fi, Bluetooth Low Energy, satellite 130, or any other kind of system.

By the network 106 the back end computing systems 102 are able to communicate with remote systems such as but not limited to flying drones 110 and/or terrestrial driving drones 112. Again, communication with these remote vehicles 110, 112, could be through any of various wired or wireless systems, respectively 120, 130 such as but not limited to cellular, Wi-Fi, Bluetooth Low Energy, satellite, or any other kind of wireless system. In some examples, these wireless systems may include ground relay stations or networks of satellites, ground relay stations, and other wired and wireless transmitters in any combination of the above.

Tasks such as mission planning, mission execution, sensor reading, sensor data analysis, vehicle maintenance, and many other scalable tasks may be coordinated and systematized at the back end computing system 102 for any number of multiple remote vehicles 110, 112. Such examples may produce a solution that is scalable and flexible with respect to the number of sensors, vehicles, users, and/or monitoring sites.

In some examples used here, the term responsibility may refer to who or what is responsible for making and executing final decisions during problem resolution. In some examples, a problem resolution(s) or Resolution(s) may mean changes to the current system, including plans that system may have, designed to eliminate or mitigate a problem. In some examples, a Level of Automation (or LOA) may mean the degree of responsibility allocated to automation in the execution of a task. In some examples, a System State may mean the description of a current or currently predicted physical state of the system, including plans and goals, along with a description of relevant environmental variables. In some examples a Candidate Resolution System State may mean the description of a predicted system state if a particular resolution to a current problem was adopted.

It should also be noted that the examples using coordinated drones and remote vehicles is just exemplary and not in any way limiting. The concepts could apply to any number of implementations. The usage of drones as examples is not intended to limit the scope in any way.

Automation—ALTA Examples

In some examples, the coordination of these drone fleets and their sensors may be operated using various levels of automation. In some examples, that may be fully autonomous. In some examples, it may be semi-autonomous. In some examples, it may be minimally autonomous. The systems and methods here may be used to make decisions on what level of autonomy may be used in coordinating these drone fleets, for example, and then execute that designated level of automation.

An Automation Level-based Task Allocation (ALTA) agent is an example software construct designed to determine the degree of responsibility to allocate to automation in task execution. The degree of responsibility may be referred to as Level of Automation. Levels of automation have been defined in various contexts. The definitions can be classified with respect to different criteria. In particular, allocation can be based upon function, such as information acquisition, information analysis, decision selection, and action implementation. Or, allocation can be based upon an ordered set of automation responsibilities, with each level reflecting an increase in automation responsibilities, ranging from no automation responsibility (human fully responsible), to automation responsible for suggesting (human decides and implements) and finally, at the extreme automation fully responsible for coming up with and implementing a resolution (no human responsibility).

Systems and methods here include the design of an automated agent for the ordered set of automation responsibilities example, in the performance of a task. In some examples described here, tasks may be referred to as problems that need to be resolved and systems and methods here may be used for assignment of responsibility based upon a multi-dimensional evaluation of the quality of the proposed resolution.

This approach may differ from other approaches that assign responsibility based on the presumed capability of the automation to do a task. In some examples data information may be used by the ALTA systems and methods to determine one or more proposed problem resolutions. In such examples, ALTA may determine the appropriate LOA for these resolutions using a set of user-supplied criteria. In such a way, the systems and methods here may use software or other mechanisms for generating problem resolutions.

In such examples, in addition to the responsibilities that it allocates to humans, ALTA may also direct automation to provide information and tools to aid the human in the performance of their responsibilities. For example, in an aircraft drone example, if a predicted collision is detected, the ALTA agent may assign the responsibility for avoiding the collision to either automated systems or to the human pilot/human ground operator. If it allocates it to the human pilot, then it may also direct that a display of the conflict, along with conflict resolution tools, be provided to the human pilot through a user interface, thereby augmenting the information available to the human pilot for decision making.

Real World Drone Deployment Examples

The following sections will provide architecture flow examples for ALTA. In order to best illustrate these examples, a non-limiting and only example reference scenario has been constructed to accompany them. In the reference scenario an earthquake has shaken a landfill and caused methane leaks. These leaks are spots on the ground where cracks have opened up and significant amounts of methane, a potent greenhouse gas, are being emitted. In order to rapidly locate these leaks, the landfill company intends to dispatch five methane sensing drones (110 in FIG. 1) overseen by one ground operator from an offsite staging location (102 in FIG. 1) located ten miles from the landfill. The five drones 110 are assigned to search different regions of the landfill. The flight plan (shown for example as dashed lines in FIG. 1) for each of the five drones (110) is comprised of three parts: the first part 150 of each flight plan specifies the flight path over the ground to the landfill, a 30-mph groundspeed and an altitude of 400 feet. The second part of each flight plan specifies a break from the group 152, 154, 156, 158, 160 where different flight paths are assigned individually for each drone while searching within the landfill, at 10-mph groundspeed, and an altitude of 50 feet. This change in speed and altitude while searching the landfill is needed to optimize methane sensor sensitivity to the methane leaks—any kind of customization of the specific mission could be utilized here, and these examples are not intended to be limiting. The third part of the flight plan 150 follows a reverse, inbound leg of the outbound flight path 150 specified in the first part, also at 30 mph and 400 feet. The five drones 110 leave with a variety of initial battery levels, ranging from 10000 mAh to 14000 mAh. During the mission ALTA is configured to continuously monitor for any number of problems, in this example, three potential problems, 1) insufficient battery reserve (projected battery charge at the end of the mission) to safely complete the mission; 2) poor predicted sensing of methane leaks; and 3) coming to close to, or penetrating, geofenced (cordoned off) airspace regions. The operator occupies a ground station 102 at the offsite staging location. The ground station is composed of a computer workstation including several display monitors. The workstation provides the operator with situation awareness on the 5 drones 110, computer input such as but not limited to a keyboard, mouse, touchscreen, joystick, voice inputs, mission status monitoring software which includes alerting, ALTA software, plus command and control links to the drones 110. These links rely primarily upon a direct radio connection, though an indirect satellite link 130 connecting the drones to the internet 106, and the internet to the ground station 120, may also be present. Internet links 106 to outside sources of information such as weather from the National Weather Service and notices of airspace closures from the FAA, may also be present. If all goes as planned the mission will execute autonomously, and the operator will not have to do anything once the drones launch, except to monitor their status.

But in some examples, the actual mission may not go as planned. The drones 110 are dispatched without incident but, as they arrive at the landfill, ALTA is updated with new information from the FAA via the internet about an airspace closure that causes it to detect a problem. The new information is that, at the police's request, the FAA has geofenced, that is cordoned off, the airspace directly above a region 170 lying along the planned return inbound path 150 from the landfill, and no drones are permitted to enter this area. ALTA detects this as a problem, i.e. the current route is cutting across the geofenced region 170. ALTA then pulls up six contingency flight plans, for example, stored on the ground station's disk drive 104, as potential resolutions. Example contingency plans 1-3 specify immediate returns using alternate flight paths 162 from the landfill back to the offsite staging location and forgoing the landfill inspection. These are flight paths that have been previously determined to avoid passing over highly populated areas. Example contingency plans 4-6 also use these same flight path 162, but only after completing the landfill inspections 152, 154, 156, 158, 160. Furthermore, example contingency plans 4-6 differ in the altitudes that they use when flying over the landfill, flying at 50 feet, 100 feet, and 150 feet respectively. These solutions factor in multiple variables such as when flying at lower altitudes the drones 110 have maximum methane sensing sensitivity, while at higher altitudes the drones use less battery energy.

Using an algorithmic process (described later), ALTA determines the appropriate LOA for each drone. ALTA then 1) radios instructions to three 110 to execute a contingency plan that ALTA has identified as the preferred resolution and, after which the operator is notified of the change on the operator interface ground station 102; 2) instructs the preferred plan for one drone to be made available on the interface to the operator, and to then be executed after a fixed duration unless countermanded, overridden, or cancelled by the operator. In an example where a user issues a countermand instruction, ALTA instructs all acceptable contingency routes to be made available to the operator who, in turn, must either select and execute one of these or create and execute a new resolution; 3) instructs all acceptable contingency routes for one drone to be immediately made available to the operator who must either select and execute one of these or create and execute a new resolution. These three alternatives are the ALTA LOA levels, Auto, Veto, and Select respectively. If ALTA had found no acceptable alternatives then the LOA would be Manual, with no resolution presented and the operator required to generate a resolution without aid.

High Level Architecture ALTA Examples

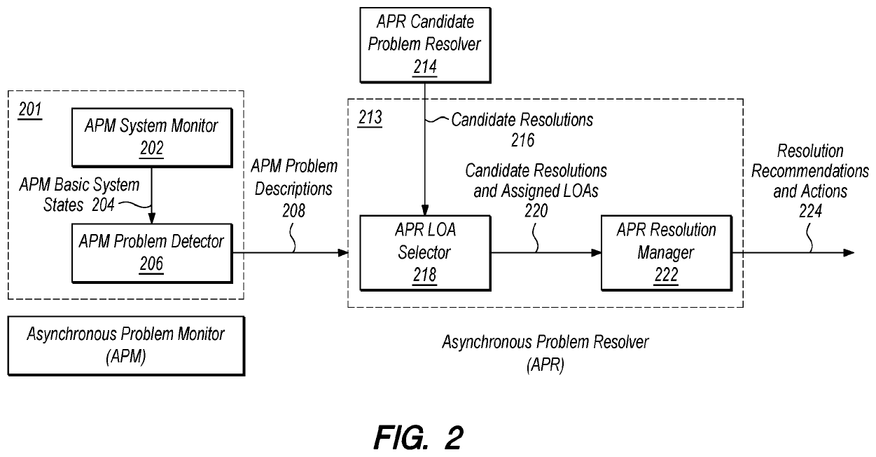

FIG. 2 shows examples of the highest-level architecture that is configured to coordinate the various assets (e.g. the aerial drones in the reference of FIG. 1) as described herein. The highest-level description of this entire system is that it may be configured to detect problems, for which it then crafts or retrieves one or more candidate resolutions, orders the resolutions in terms of preference, and then lastly determines the LOA governing the processes of presentation, selection and execution of a single resolution. For the reference scenario the problem was a drone crossing into a geofenced region, and the final resolution was a new flight plan for that drone. The architecture models described herein may reside and/or be executed on the computing systems 102 and/or 104 as shown in FIG. 1.

The main architecture includes two superordinate functions that each encompass subordinate functions. The first superordinate function as shown in FIG. 2, The Asynchronous Problem Monitor 201, (abbreviated APM), has the subordinate functions APM System Monitor 202 and APM Problem Detector 206, and three associated inputs/outputs: APM Basic System States 204, and APM Problem Descriptions 208 which is also the ultimate output of the APM 201. The overall role of the Asynchronous Problem Monitor (APM) 201 is to continuously monitor critical states of the overall system in search of Problems. For the reference scenario example, these critical states are composed of the Basic System States current battery charge (received from the Drone via a radio link), current flight plan (stored on the ground station 102, 104), and current geofenced regions (received from F7 via internet and stored on ground station 104), along with the Higher Order States predicted battery reserve, predicted methane sensing capability, proximity of current flight path to geofenced regions (all calculated on the ground station 102); and the Problems are insufficient battery reserve, poor predicted sensing of methane leaks, and planned flight path crossing a geofenced region, all detected via the ground station monitoring software 102. Problems, when found, are sent to the Asynchronous Problem Resolver (APR) as APM Problem Descriptions.

The second superordinate function, the Asynchronous Problem Resolver 213, (abbreviated APR), utilizes the outside function APR Candidate Problem Resolver 214, the subordinate functions APR Level of Automation (LOA) Selector 218 and APR Resolution Manager 222, and has four associated inputs/outputs: APM Problem Descriptions 208, Candidate Resolutions 216, Candidate Resolutions with Assigned LOAs 220, and Resolution Recommendations and Actions 224. For each of these APM Problem Descriptions the overall role of the APR is to retrieve one or more candidate resolutions from the APR Candidate Problem Resolver 214, evaluate the quality of each resolution, and decide upon the appropriate LOA (Auto, Veto, Select, Manual) for selecting and executing a candidate resolution. For the reference scenario examples, these candidate resolutions are the six contingency flight plans pre-stored at the ground station.

Still referring to FIG. 2, the APM System Monitor 202 continuously outputs APM Basic System States 204 to the APM Problem Detector 206. APM Basic System States 204 are descriptions of current or currently predicted physical states of the system, including plans, goals (e.g. things that define mission success), and descriptions of relevant external variables. For the reference scenario example, the Basic States outputs by the APM System Monitor 202 are a drone's current battery charge, which may be obtained via radio or internet links with the drone, flight plan which may be stored and updated either locally or non-locally (e.g. a cloud service), plus geofenced regions to be avoided which may be obtained via internet or telecom links.

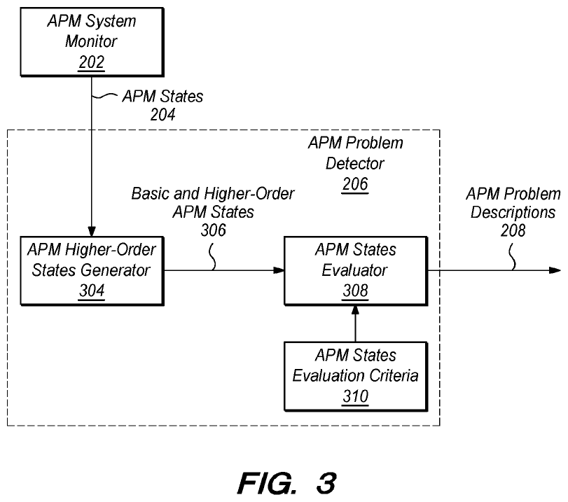

Turning to FIG. 3 the detailed example of the APM Problem Detector 206: The APM System Monitor 202 outputs APM Basic System States 204 that may be fed into the APM Problem Detector 206. The APM Problem Detector 206 utilizes the APM Basic System States 204 to detect problems and output APM Problem Descriptions 208. An APM Problem Description 208 may be a description of an off-nominal APM Basic or Higher-Order State 306. It may include the values of all states relevant to the Problem, plus the criteria that divide nominal (no Problem) from off nominal (Problem) states. When Problems are detected they may incur an alarm or other communication. For the reference scenario example, APM Basic System States 204 would be current battery charge and flight plan, and geofenced regions; the problems to be detected would be insufficient battery reserve, poor predicted sensing of methane leaks, and planned flight path crossing a geofenced region. For example, in the reference scenario example, when the police cordon occurred, the measure of proximity to geofenced regions would drop to zero since the planned flight path would cut through it and such a penetration would generate a problem description

A more detailed look shows the APM Problem Detector in FIG. 3 is composed of two subordinate functions, the APM Higher-Order States Generator 304 and APM System States Evaluator 308, plus a component 310 that provides the APM System States Evaluation Criteria. These APM System States Evaluation Criteria 310 may be in the form of a stored list. However, this component may also dynamically determine or calculate these criteria. Here dynamic means that this component may compute or determine these criteria utilizing other parameters, particularly those taken from the current context. For the reference scenario example, that means the battery reserve criteria could be set to either a fixed value, such as 500 mAh, or a dynamic value such as 125% of the battery charge currently estimated to be needed to complete the mission. The value of this dynamic criteria would drop over time because the battery charge required to complete a mission drops. For example, halfway through a flight, if everything progressed as expected, required battery charge would only be that needed to complete the last half of the flight.

To detect APM Problems the APM System States Evaluator 308 may evaluate not only basic APM System States 204 provided by the APM System Monitor 202, but also Higher-Order APM System States 306, the latter produced by the APM Higher-Order States Generator function 304. The APM Higher-Order States Generator 304 may produce new higher-order state descriptions by combining and/or transforming multiple APM System States 204. The APM State Evaluator 308 may be configured to detect problems by comparing these basic and Higher Order APM System States 306 with the APM System States Evaluation Criteria 310 to determine if these state variables are off-nominal. When off-nominal states are detected they are output as APM Problem Descriptions (208 in FIG. 2 and FIG. 3). For the reference scenario example, the predicted battery reserve, predicted methane sensing capability, and proximity of current flight path to geofenced regions are all calculated values, and thus higher-order states. Here the APM Higher Order States Generator 304 determines proximity of a drone's current flight path to all geofenced regions. Thus, when the geofenced region is instituted due to police cordon, APM Higher Order States Generator 304 produces a proximity of the current flight path to geofenced regions. If this is less than a value stored in the APM State Evaluation Criteria 310, this is detected by the APM States Evaluator 308 and an APM Problem description 208 is generated that would include the geofence location state, the current flight plan state, the proximity of the geofence to the current flight path, and the evaluation criteria. Similar computations and comparisons could be produced for expected methane leak detection where the higher order state predicted methane sensing capability is a function of predicted altitude state (part of the flight plan state), and predicted battery reserve at mission completion, a function of current flight plan state and current battery charge.

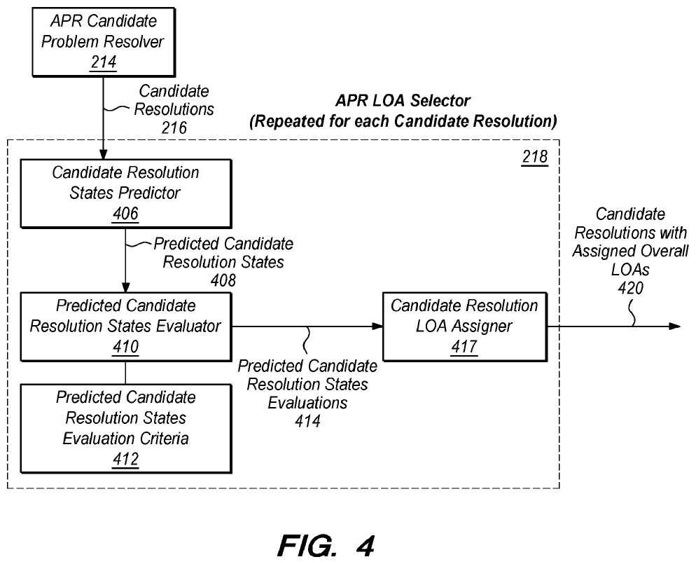

APR Candidate Problem Resolver: The APR's Candidate Problem Resolver 214 (as shown in FIG. 2 and FIG. 4) may be configured to take as input the APM Problem Descriptions output 208 by the APM and generate one or more Candidate Resolutions 216 to those problems. The specifics of the operation of the APR Candidate Problem Resolver 214 are specific to the types of problems being handled. Anything that can provide such resolutions may be used, including, but not limited to, pre-stored lists of candidate resolutions to specific problems, and dynamically created candidate resolutions. For the reference scenario the resolutions to the problem of crossing the geofenced boundary are obtained from the list of contingency flight plans that were previously developed with the goal of minimizing overflights of populated areas. Another example, would be a drone that is running low on battery power, with resolutions obtained from a list of potential alternate onboard power sources and/or from dynamically calculated flight plans that allow it to land as soon as possible.

APR LOA Selector: The APR LOA Selector 218 (as shown in FIGS. 2 and 4) may be configured to take as input Candidate Resolutions 216 from the Candidate Problem Resolver 214 and assign levels of automation to each of these Candidate Resolutions 216 based on the Predicted Candidate Resolution States 220 they produce. As shown in the detail of FIG. 4, the APR LOA Selector 218 may contain up to three functions, the Candidate Resolution States Predictor 406, the Predicted Candidate Resolution States Evaluator 410, and the Candidate Resolution LOA Assigner 417; and one component that supplies evaluation criteria, the Predicted Candidate Resolution States Evaluation Criteria 412. For each Candidate Resolution 216 the Candidate Resolution States Predictor 406 may be configured to generate Predicted Candidate Resolution States 408. The specifics of the operation of the Candidate Resolution States Predictor 406 may depend on the types of candidate resolutions being generated by the APR Candidate Problem Resolver 214. The Predicted Candidate Resolution States 408, although similar to an output of the System Monitor 202, are now states to be expected if the candidate resolution was used, and not the states of the current system. All Predicted Candidate Resolution States 408 for a Candidate Resolution 216 may be individual inputs for the Predicted Candidate Resolution States Evaluator 410. In addition, Predicted Candidate Resolution States Evaluation Criteria 412 may also be inputs for the Predicted Candidate Resolution States Evaluator 410. These criteria may be stored values and/or algorithms, and may be used to produce a set of Predicted Candidate Resolution States Evaluations 414.

The evaluations output 414 by the Predicted Candidate Resolution States Evaluator 410 specify the maximum LOA that each of the Predicted Candidate Resolution States 408 may support for a particular Candidate Resolution 420. The Overall LOA assigned to a Candidate Resolution 420 may depend on all the Predicted Candidate Resolution States' 408 maximum LOAs. Each Predicted Candidate Resolution State LOA 420 there may be assigned one of four values by the Predicted Candidate Resolution States Evaluator 410, Autonomous (or Auto), Veto, Select, and Manual. These range, respectively, from least operator involvement to greatest operator involvement. Autonomous specifies that the Candidate Resolution State is sufficient to support execution of the associated Candidate Resolution without any operator involvement in selecting and executing the Candidate Resolution. Veto specifies that the Candidate Resolution State is sufficient to support autonomous execution of the Candidate Resolution if the operator is allowed a predefined period of time (e.g. 30 seconds) in which to countermand, or ‘Veto’ the autonomous execution. Select specifies that the Candidate Resolution State is acceptable, but the Candidate Resolution may not be executed without direct operator approval. For any Problem there may be multiple Candidate Resolutions classified as Select. Thus, Select may requires operator involvement in both selecting and executing the Candidate Resolution. Manual specifies that the Candidate Resolution State is not considered acceptable and operator involvement is required for developing (not just selecting) and executing a Candidate Resolution 420.

Once the LOA Predicted Candidate Resolution States Evaluator 410 has produced all Predicted Candidate Resolution States Evaluations 420 for a Candidate Resolution 216, these may be turned over to the Candidate Resolution Assigner 417. The Candidate Resolution Assigner 417 then assigns an Overall LOA to the Candidate Resolution 420 that is the lowest of these individual LOA evaluations. This ensures that the Overall LOA for a Candidate Resolution 216 is constrained to an LOA that is supported by all Predicted Candidate Resolution State Evaluations 414. Once all of the Candidate Resolutions 216 have been assigned LOAs, they may be output as Candidate Resolutions with Assigned Overall LOAs 420.

The reference scenario example can be used to illustrate the operation of the APR LOA Selector 218. In the reference scenario the problems of all five drones crossing the geofenced region has been detected by ALTA just as they have arrived at the landfill, and now need resolutions. The Candidate Problem Resolver 214 produces the same six Candidate Resolutions 216 for all five drones by taking them from the stored list of contingency flight plans. In other applications the Candidate Problem Resolver 214 might produce different Candidate Resolutions 216 for different drones. After receiving the six Candidate Resolutions 216 the Candidate Resolution States Predictor 406 then generates the Predicted Candidate Resolution States 408, which are predicted battery reserve, predicted methane sensing capability, and predicted proximity of flight path to geofenced regions. Here the states used to evaluate the Candidate Resolutions directly correspond to the states that are used to define the detected Problem, but this is not necessary. Additional Predicted Candidate Resolution States such as population density along the proposed path could also be included.

Table 1 and Table 2 show possible example predictions of the three predicted candidate resolution states 408 for the original flight plan and for the six candidate resolutions 216. Example Table 1 shows this for one drone and Example Table 2 for a different drone. These are the values that are input into the Predicted Candidate Resolution States Evaluator 410 together with the Predicted Candidate Resolution States Evaluation Criteria 412, which are shown in Table 3. The Predicted Candidate Resolution States Evaluator 410 then produces the Predicted Candidate Resolution States Evaluations 414 which are shown in row 1-3 of Tables 4 and 5. For example, in Table 2, Row 1 shows that Resolution 6 for Drone 2 has a Predicted Battery Reserve of 2127 mAh, which is above the 2000 mAh specified in Table 3 as necessary for Autonomous execution of Resolution 6; while in Table 1 Drone 1's Predicted Battery Reserve of 1995 mAh for Resolution 5 is between the 1000 mAh and 2000 mAh specified in Table 3 as necessary for Veto-level execution. Auto and Veto have therefore been entered as Predicted Candidate Resolution States Evaluations 414 in corresponding cells of Tables 4 and 5. Finally, these evaluations shown in rows 1-3 of Table 4 and 5, are delivered to the Candidate Resolution LOA Assigner 417 which produces an Assigned Overall LOAs 420 for each Candidate Resolution 216. The rule for determining these Overall LOA assignments, shown in row 4 of Tables 4 and 5, is that the Overall LOA is the lowest LOA assigned to any of the Predicted Candidate Resolution States. For Resolution 6 in Table 4, the LOAs assigned to the three Resolution States are (Auto, Select, Select), thus the Overall Candidate Resolution LOA is Select. The entire APR LOA Selector process is applied once for each Candidate Resolution, to get six LOAs for each drone.

TABLE 1
Reference Scenario Example: Predicted Candidate Resolution States
for Drone 1 Candidate Resolutions when Geofence Erected

| | | | Drone 1 Candidate Resolutions | | | | | |
|---|---|---|---|---|---|---|---|---|
| | Predicted Candidate Resolution | Original | Res. | Res. | Res. | Res. | Res. | Res. |
| Row | State | Flight Plan | 1 | 2 | 3 | 4 | 5 | 6 |
| 1 | Predicted Battery Reserve (mAh) | 4864 | 10023 | 10198 | 9805 | 4864 | 4995 | 5127 |
| 2 | Predicted Methane Sensing | 100 | 0 | 0 | 0 | 100 | 87 | 80 |
| | Capability (% of optimum) | | | | | | | |
| 3 | Predicted Flight Path Proximity to | 0 | 1.2 | 0.85 | 0.6 | 1.2 | 0.85 | 0.6 |
| | Geofenced Regions (miles) | | | | | | | |

TABLE 2
Reference Scenario Example: Predicted Candidate Resolution States
for Drone 2 Candidate Resolutions when Geofence Erected

| | | | Drone 2 Candidate Resolutions | | | | | |
|---|---|---|---|---|---|---|---|---|
| | Predicted Candidate Resolution | Original | Res. | Res. | Res. | Res. | Res. | Res. |
| Row | State | Flight Plan | 1 | 2 | 3 | 4 | 5 | 6 |
| 1 | Predicted Battery Reserve (mAh) | 1864 | 7022 | 7050 | 7100 | 1864 | 1995 | 2127 |
| 2 | Predicted Methane Sensing | 100 | 0 | 0 | 0 | 1 | .87 | .80 |
| | Capability (% of optimum) | | | | | | | |
| 3 | Predicted Flight Path Proximity to | 0 | 1.2 | 0.85 | 0.6 | 1.2 | 0.85 | 0.6 |
| | Geofenced Regions (miles) | | | | | | | |

TABLE 3
Reference Scenario Example: Predicted Candidate
Resolution States Evaluation Criteria

| | Candidate Resolution State | | Predicted |
|---|---|---|---|
| | | Predicted | Flight Path |
| | Predicted | Methane | Proximity to |
| | Battery | Sensing | Geofenced |
| | Reserve | Capability | Regions |
| LOA | (mAh) | (% of optimum) | (miles) |
| Auto: Implement | Battery >= | Sensing >= | Proximity >= |
| Resolution | 2000 | 0.9 | 1 |
| Automatically | | | |
| Veto: Implement | 1000 <= | 0.85 <= | 0.75 <= |
| Resolution | Battery < 2000 | Sensing < 0.9 | Proximity < 1 |
| Automatically | | | |
| if not Vetoed | | | |
| by human before | | | |
| some critical | | | |
| time interval | | | |
| or event | | | |
| Select: Require | 500 <= | 0.75 <= | 0.5 <= |
| human to | Battery < 1000 | Sensing < 0.85 | Proximity < 0.75 |
| OK the | | | |
| recommended | | | |
| resolution | | | |

TABLE 4
Reference Scenario Example: Predicted Candidate Resolution
and Overall Autos for Drone 1 Candidate Resolutions

| | Predicted | | | | | | |
|---|---|---|---|---|---|---|---|
| | Candidate | Drone 1 Candidate Resolutions | | | | | |
| | Resolution | Res. | Res. | Res. | Res. | Res. | Res. |
| row | State | 1 | 2 | 3 | 4 | 5 | 6 |
| 1 | Predicted | Auto | Auto | Auto | Auto | Auto | Auto |
| | Battery | | | | | | |
| | Reserve | | | | | | |
| | (mAh) | | | | | | |
| 2 | Predicted | Manual | Manual | Manual | Auto | Veto | Select |
| | Methane | | | | | | |
| | Sensing | | | | | | |
| | Capability | | | | | | |
| | (% of | | | | | | |
| | optimum) | | | | | | |
| 3 | Predicted | Auto | Veto | Select | Auto | Veto | Select |
| | Flight Path | | | | | | |
| | Proximity to | | | | | | |
| | Geofenced | | | | | | |
| | Regions | | | | | | |
| | (miles) | | | | | | |
| 4 | Overall | Manual | Manual | Manual | Auto | Veto | Select |
| | Candidate | | | | | | |
| | Resolution | | | | | | |
| | LOA | | | | | | |

TABLE 5
Reference Scenario Example: Predicted Candidate Resolution
and Overall LOAs for Drone 2 Candidate Resolutions

| | Predicted | | | | | | |
|---|---|---|---|---|---|---|---|
| | Candidate | Drone 2 Candidate Resolutions | | | | | |
| | Resolution | Res. | Res. | Res. | Res. | Res. | Res. |
| row | State | 1 | 2 | 3 | 4 | 5 | 6 |
| 1 | Predicted | Auto | Auto | Auto | Veto | Veto | Auto |
| | Battery | | | | | | |
| | Reserve | | | | | | |
| | (mAh) | | | | | | |
| 2 | Predicted | Manual | Manual | Manual | Auto | Veto | Select |
| | Methane | | | | | | |
| | Sensing | | | | | | |
| | Capability | | | | | | |
| | (% of | | | | | | |
| | optimum) | | | | | | |
| 3 | Predicted | Auto | Veto | Select | Auto | Veto | Select |
| | Flight Path | | | | | | |
| | Proximity to | | | | | | |
| | Geofenced | | | | | | |
| | Regions | | | | | | |
| | (miles) | | | | | | |
| 4 | Overall | Manual | Manual | Manual | Veto | Veto | Select |
| | Candidate | | | | | | |
| | Resolution | | | | | | |
| | LOA | | | | | | |

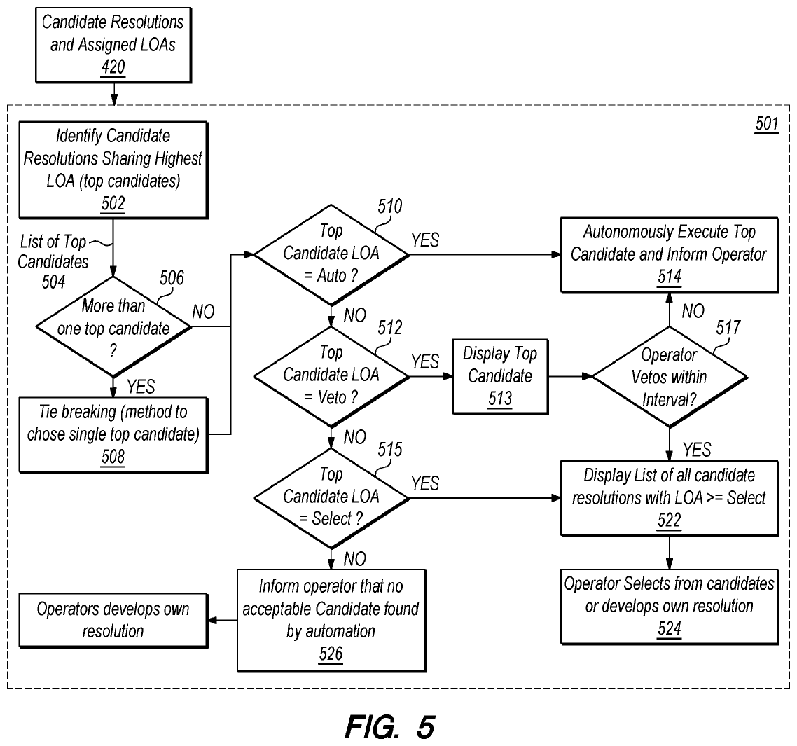

The APR Resolution Manager: The APR Resolution Manager 222 shown in FIG. 5 may take as input the set of all Overall Candidate Resolutions and Assigned LOAs 220. The final output of the APR Resolution Manager is either 1) an autonomous execution of a “top” resolution 514; 2) the presentation of a list of candidate resolutions on an operator interface 522 ordered from most to least recommended and from which the operator may choose to select; or 3) a notification that the automation has no found no acceptable candidate resolutions.

The APR Resolution Manager 501 may include multiple functions. In some examples, the APR Resolution Manager 501 may include six functions: Identify Candidate Resolutions Sharing Highest LOA 502, Tie Breaking 508, Display Ordered Recommendation List 522, Display Top Candidate 513, Inform Operator that No Acceptable Candidate Found by Automation 526, and Autonomously Execute Top Candidate 514. Any combination or number of these or other functions may be utilized, and this list is not intended to be limiting. For example The APR Resolution Manager 501 may initially receive as input, the Candidate Resolutions with Assigned LOAs 320 output by the APR LOA Selector 218, identify all candidates sharing the highest LOA 502, and output these as the Top Candidate Resolutions 504. If there are multiple Top Candidate resolutions, then the system may employ a Tie Breaking method to narrow to a single top candidate resolution (508). There may be multiple methods that could achieve this, and one example is random selection using a random number generator.

Level of Autonomy Determination and Execution Examples

Once there is a single top candidate resolution, then the system determines if this candidate has an LOA of Autonomous 510. If it does, then the system autonomously executes the top candidate resolution and informs the operator 514.

If the top candidate resolution is not Autonomous, then the system determines if the top candidate resolution LOA is Veto 512. If it is then the system displays the Top Candidate 513 and, if the operator does not countermand (veto) this 517 before a preset duration has elapsed, autonomously executes it and informs the operator 514. If the operator vetoes this autonomous execution, then the system may display a list of all candidates with LOAs at the Select level and above 522 and wait for the operator to either select from one of these candidate resolutions or develop a new resolution.

If the top Candidate Resolution LOA is neither Auto or Veto, then the system determines if the LOA is Select 515. If the system determines that the top Candidate Resolution LOA is Select then the system displays a list of all candidate resolutions s with LOAs at the Select level and above 522 and waits for the operator to either select from one of these candidate resolutions or develop a new resolution.

If there is no top candidate resolution with an LOA at the Select level and above, then the operator is informed that no acceptable candidate resolution has been found by the automation and turns the problem fully over to the operator to manually find a resolution 526.

Except in the case of a top candidate resolution with an assigned LOA of Autonomous, the operator may modify any displayed candidate resolutions or ignore all of them and create and execute the operator's own resolution.

Returning to the reference scenario example, Row 4 of Tables 4 (Drone 1) and Table 5 (Drone 2) show the highest LOA and the associated Top Candidate Resolution(s) in bold type face. For Drone 1 the highest candidate resolution LOA is Auto, and only candidate resolution 4 has this LOA. Therefore, the candidate resolution 4 flight plan is uploaded to Drone 1 via radio link and autonomously executed without further operator involvement and the operator informed via the user interface. For Drone 2 the highest candidate resolution LOA is Veto, and this is shared by candidate resolutions 4 and 5. As a result, in order to break this tie and get a single Top Candidate, the system uses a random choice method to select just one of these, e.g. candidate resolution 5, which it then displays on an interface to the operator. If the operator does not veto this, then candidate resolution 5 plan is uploaded to Drone 2 via radio link and autonomously executed without further operator involvement, and the operator informed via the user interface. If the operator decides to veto it (using some element of the interface such as a button), then the full list of all six resolutions will be presented to the operator via the interface, who may then select or modify one of these, or develop a new resolution using other tools provided specifically for this purpose.

Play Based Hat Architecture

Another aspect discussed here includes a human-automation teaming architecture consisting of so-called plays that may allow a human to collaborate with the automation in executing the tasks.

A play may include the breakdown of how and by whom decisions for tasks are made towards a commonly understood goal. In some examples, at the highest level the user can place a play into motion by the automation or by an operator calling it from a playlist, such as for example, a play contained in the playbooks of sports teams, where the operator has supervisory control in a role akin to the coach of a team. Calling a play may consist of providing the specification of a desired goal via the play user interface, which then uses a shared vocabulary between operator and resources of how to achieve it.

Plays described herein may include the potential for human involvement beyond just the calling of the play. The degree to which human-versus-automation involvement is required has been referred to as the level of automation, or LOA, and spans a spectrum from fully autonomous decisions and executions with no human involvement through fully manual operation with no role for automation.

Dynamic determination of the level of automation may refer to adjusting the LOA on any particular task in response to how well, relative to operator determined criteria, the automation is able to handle any specific task. ALTA may be used to dynamically determine the LOA, although in some examples, the human operator may be given the responsibility for adjusting the criteria which ALTA uses to determine LOA. Furthermore, if the operator desires, s/he can set and fix the LOA on specific plays.

Using ALTA to set LOA for tasks may take the moment-to-moment meta-task of making individual task delegation determinations away from the human operator. This may be useful in high workload situations to assign a task. In order to implement this however, the human operator or supervisor would be required to provide, ahead of time, the criteria for assigning the LOA. These criteria and context (e.g., commercial aviation) must prominently include various types of risk (e.g., to people, to vehicle, to infrastructure); secondarily include factors that impact efficiency and cost (e.g., missed passenger and crew connections, and fuel); and less critical elements such as bumpy rides and crew duty cycles. Using these criteria ALTA can judge when solutions about things like aircraft routing derived by the automation are good enough for autonomous execution, when they require operator approval, or when they are so poor the entire problem must be handed to the operator with no recommendations.

In some examples, Plays may be arranged in hierarchical composition, with other tasks and subplays nested within them. It is worth noting that the subplays can, in other contexts, be plays that the operator directly calls. So the design of a play may involve the selection and combining of subplays. Plays and subplays may also be modified or tailored prior to, or sometimes during, play execution. The possible paths to achieving the goal may be adjusted as the situation evolves, either through dynamic assignment of LOA by ALTA or through direct specification from the operator (e.g., changes to parameters determining this assignment of LOA).

By utilizing the play concept, a human operator's capabilities may be enhanced by the ability to quickly place a coordinated plan in motion, monitor mission progress during play execution, and fine-tune mission elements dynamically as a play unfolds.

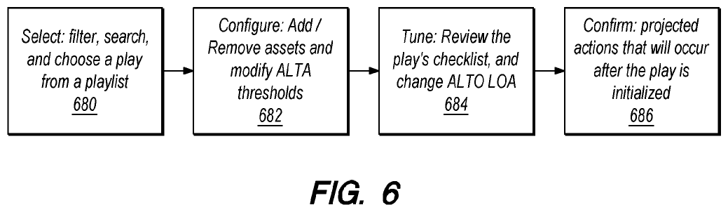

FIG. 6 shows an example flow diagram dealing with plays. A human-automation integration architecture described here may provide a unifying and coherent form for structuring nodes, which are inputs, tasks, and subplays that together define a play, and connecting nodes into a node graph to achieve a specified goal of a play. The example structuring process shown in FIG. 6, consists of four key stages: Select 680, Configure 682, Tune 684, and Confirm 686. The Select stage 680 allows a user/operator to filter and select a play from a playlist which consists of a bank of available plays. The Configure stage 682 may allow the human user/operator to add or remove assets (e.g., manned aircraft, unmanned aircraft, or ground rovers) that needed to participate in the play, and to modify the ALTA thresholds if desired. The Tune stage 684 may allow the user/operator to go through the play checklist, which includes items from the node graph defined in the Select/Configure 686 stages and any additional items defined by the user. The checklist may also indicate which tasks are the responsibility of the human and which are the responsibility of the automation. For checklist items that can result in an action being generated, the human user may be allowed to override ALTA by selecting another level of automation. In the Confirm stage the human user/operator is provided with a summary of projected actions that will occur once the play is initialized. The summary may include information such as high-level description of the play, the list of assets (e.g., aircraft, vehicles) that will be involved, and the input parameters, and after confirmation, the user/operator will be updated with newly executed play.

A human autonomy teaming (HAT) system, consisting of ALTA and Play-Based human automation integration architecture described above, can be supported by a variety of potential interfaces designed to meet the special needs of particular work domains.

Play Implementation Examples

In some example embodiments, the system FIG. 1 may manage the information to be presented on any number of displays. In some examples, it may present information regarding any number of issues, problems or decisions that need to be made, along with options, to any number of operators, actively participating in collaborative decision making.

Certain examples may include offloading certain compute resources such as cloud computing for data processing, compression, and storage; Internet of Things for data transmission; artificial intelligence for pattern/image recognition; and conversational user interfaces with natural language understanding.

By networking fleets of drones working together, the sensor data may be faster than human operable drones alone, as well as providing the capability to quickly convert sensor data information into human understandable and digestible data to enable humans to make real-time decisions.

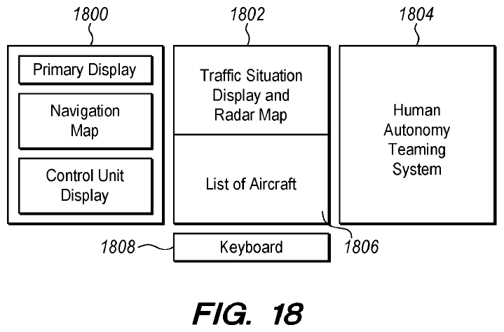

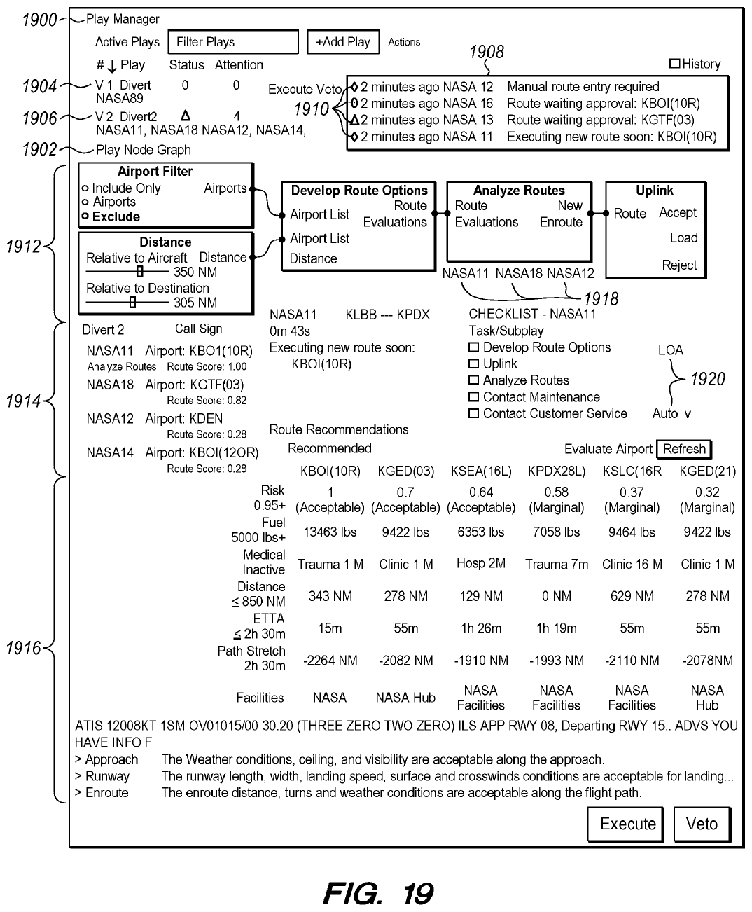

One example implementation is shown in FIG. 18 showing an example ground control station (GCS) interface. The GCS components in FIG. 18 consist of aircraft instruments for a selected aircraft (left monitor) 1800, a traffic situation display (TSD, center-top monitor) 1802, an aircraft control list (ACL, center-bottom monitor) 1806, and the human autonomy teaming system agent (right monitor) 1804. An enlarged image of the human autonomy teaming (HAT) system is shown in FIG. 19.

In the pictured example, Denver International Airport (DEN) has been closed due to a thunderstorm. This has triggered an Airport Closure play and the HAT system FIG. 19 in assisting four aircraft enroute to DEN. The HAT system FIG. 19 considers contextual factors for the affected aircraft (e.g., risk, location, weather, fuel consumption, estimated delay times, medical facilities, and airline services) to generate and analyze options to either “absorb” the delay resulting from the closure enroute (e.g., by slowing down or modifying the route to DEN) or to divert to a suitable alternate airport. These contextual factors are considered by the HAT system FIG. 19 against user defined thresholds for when the HAT system FIG. 19 can autonomously decide to set an action in motion for a given aircraft, or for when it requires greater consideration from the operator.

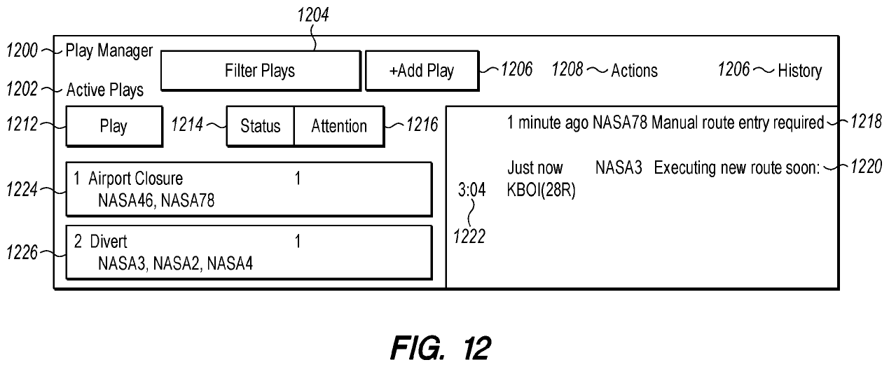

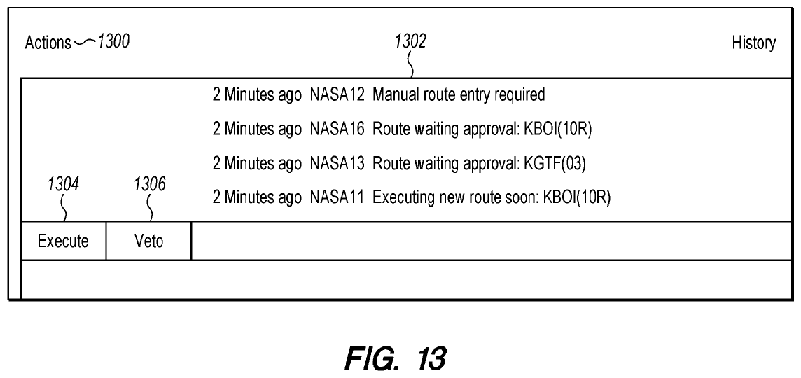

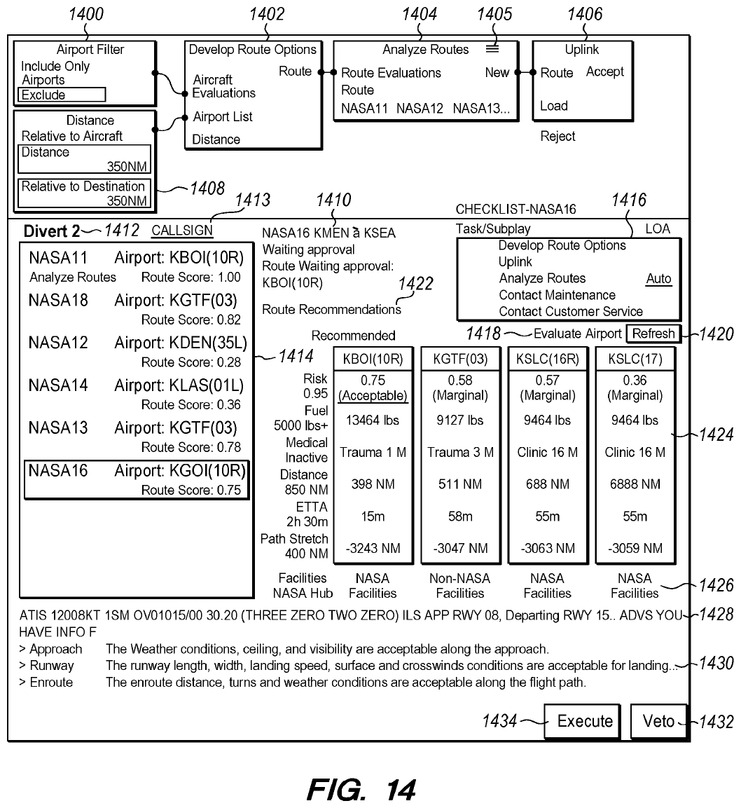

The HAT interface system shown in FIG. 19, consists of a number of principal components, including the Play Manager 1900 (additional various pages of the Play Manager are shown in FIG. 12, FIG. 13) and the Play Conductor 1902 (additional page of the Play Conductor is shown in FIG. 14). The Play Manager shows a list of actively running plays 1904 and 1906 (top left) and current actions requiring further operator input 1908 (top right). Icons 1910 in FIG. 19 are displayed next to listed actions to indicate the HAT system FIG. 19 LOA determination given user-defined contextual factors for each aircraft. Below the Play Manager is the Play Conductor, itself consisting of a “node graph” 1912 as shown in FIG. 19, center, aircraft list 1914 shown in FIG. 19, bottom-left, and a recommendation pane 1916 shown in FIG. 19, bottom-right. The node graph represents a high-level overview of the Airport Closure play as it unfolds in real time.

Nodes correspond to inputs, tasks, and subplays that together define a play. Aircraft call signs 1918 are displayed below nodes to indicate their position in the course of the play. The aircraft list shows the aircraft involved in the currently selected play along with information regarding recommended actions icons representing their respective LOAs 1920. To the right of this list is the recommendation pane 1916, which provides further details (e.g., transparency information about a given diversion and the automation's reasoning behind suggesting it) about actions suggested by the HAT system FIG. 19 for the aircraft selected in the list.

Play Selector Examples

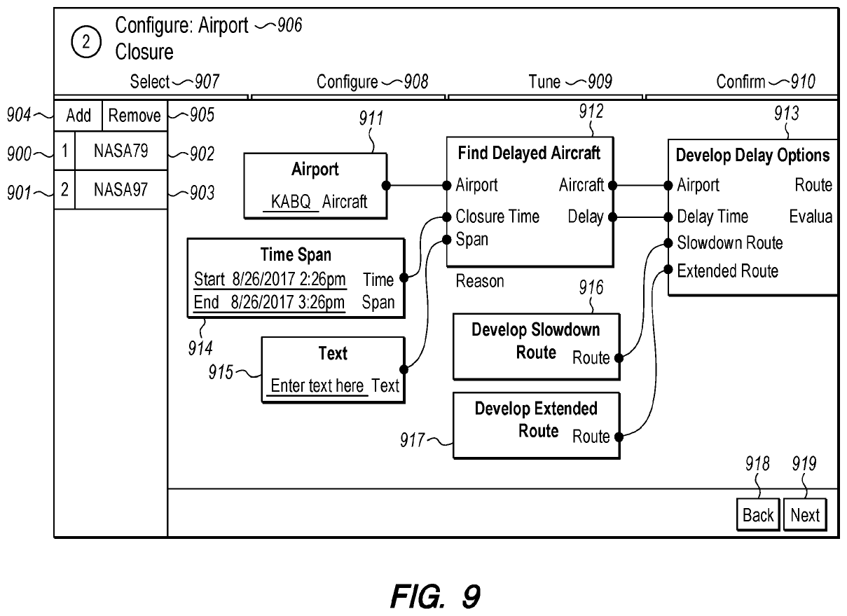

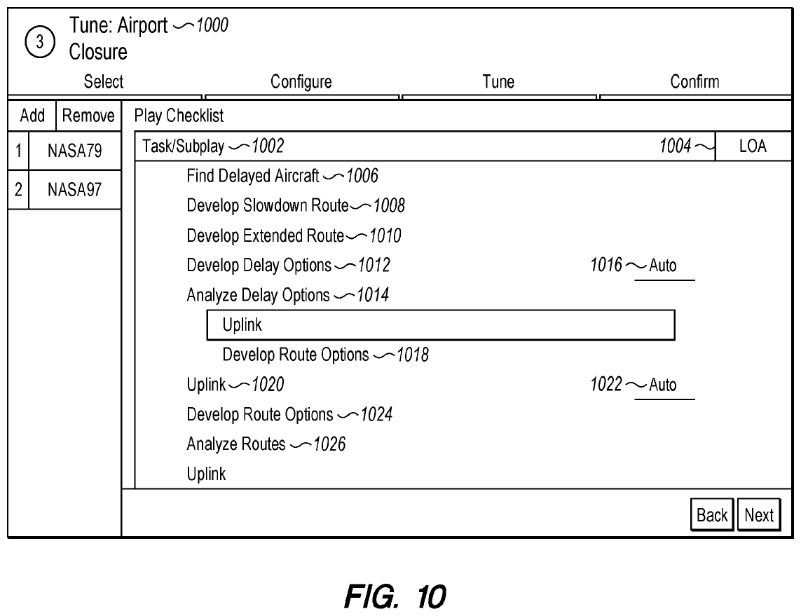

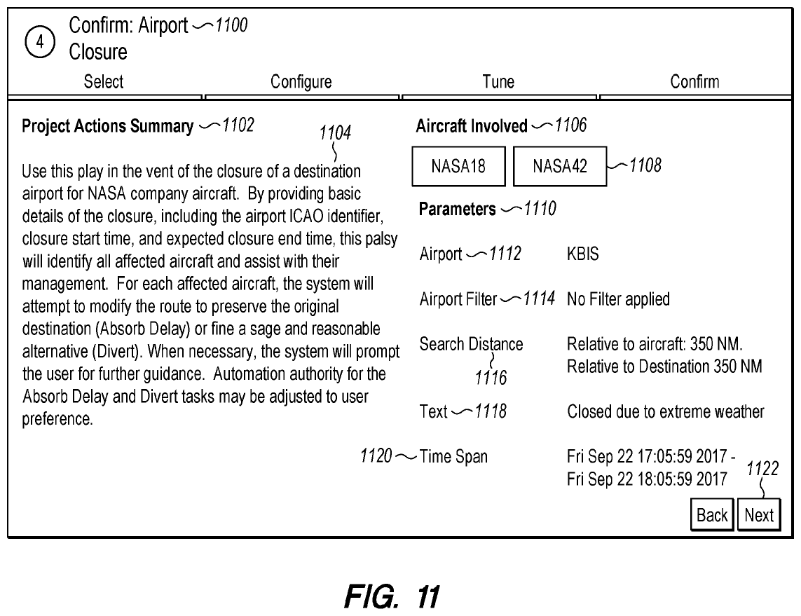

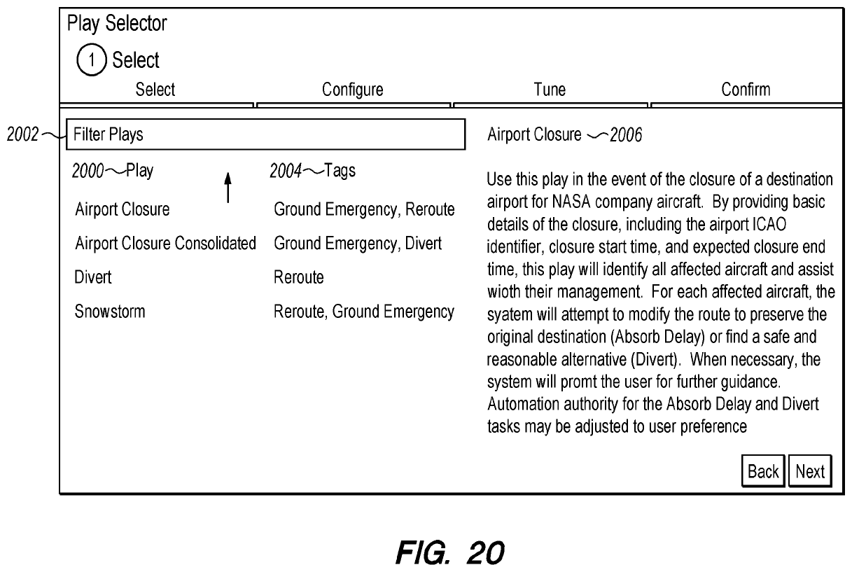

Below is a detailed description of an example of the HAT system FIG. 19. In this example, an operator may use the Play Selector wizard (various stages of the Selector are shown in FIG. 10, FIG. 11, FIG. 20) to launch a play from the main HAT interface. The wizard may be configured to guide a user through the process of selecting and configuring a play to the user's needs in a four stage process FIG. 6: Select, Configure, Tune, and Confirm. In the Select stage FIG. 20, the operator may be provided with a list of plays 2000 on the left with a search box 2002 above it that can be used to filter and search for plays. Search queries narrow the list of plays displayed by searching for tags 2004 and play names. In some example embodiments, voice interaction with this interface may be used. Once a user selects a play from the list, a play description 2006 will appear to the right corresponding to the description that was provided in the play's creation using the Play Maker (described below) and the user may now click the “Next” button in the lower right to advance to the Configure stage shown in FIG. 9 (described below).

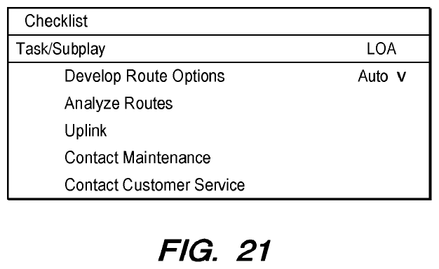

The Play Maker allows the operator to create new plays and edit existing ones. Example main components of the Play Maker includes: a node graph (described previously and shown in FIG. 19); a panel of attributes for viewing and editing play metadata (e.g., Airport 911, Time span 914, and Route 916 in FIG. 9); a checklist that lists the tasks in the play shown in FIG. 21; a Node Pool, which shows a list of all available nodes; and a Node Manager, which shows a list of nodes in the current play.

An example of the interface for the Configure stage of the Play Selector wizard is depicted in FIG. 9. The panel at the top of the interface contains the name of the play being configured (Airport Closure) 907, and the four stages of the Play Selector 907-910, presented in a color that shows which stages have been accomplished. On the left-hand side of the interface is a list of assets/vehicles involved in the play. In some examples, Add and Remove buttons allow the user to include or remove assets to the play. When possible (as in the case of the Airport Closure play) this assets list is automatically populated by the HAT system FIG. 19. In some examples versions of R-HATS that do not have the ability to involve an asset in more than one play at a time, an information icon may appear next to any asset ID that is currently involved in a running play. However, if a new play is invoked on an aircraft that is a part of an existing play, the aircraft will be moved from its original play into the new one. To the right of this asset list is a portion of the play's node graph, showing the graph as it was designed in the Play Maker. Airport 911, and Time Span 914, represent input elements of the play. These may be input automatically or manually, and represent data needed to run the play. Here the airport that is to be closed, and the times at which it is closed are the inputs. Text 915 is there so that the operator can provide additional descriptive information. Find Delayed Aircraft 912, Develop Slowdown Route 916, Develop Extended Route 917, Develop Delay Options 913, are generic sub-tasks that simply perform deterministic calculations which do not require human input review or decisions. In this case these tasks find the aircraft that are due to arrive at the airport during its closed period 912; determine if there are ways of slowing down these aircraft 916, or inserting delay legs in their flight plans 917, that will cause them to arrive after the airport is scheduled to re-open; and generate evaluations for each of these two options 913. On the other hand, Analyze Delay Options 1014 (in FIG. 10) represents a special type of sub-task, which we call a sub-play. Subplays are types of sub-tasks that include an ALTA component that governs LOA for that task. In node graphs Subplays are distinguished by a tune icon 1405 (shown in FIG. 14). The LOA assignment within the Analyze Delay Options sub-play determines how the slowdown and extended route options are handled.

During the Configure stage, an operator may provide the Play Selector with the information about their current situation to run the play. In such examples, by double-clicking clicking on a node with the tune icon 1405, a user can tweak the thresholds utilized by ALTA to assign levels of automation for various tasks and decisions involved in the play. If a user elects not to modify ALTA schedules in the Configure stage, default schedules defined during the play's creation with the Play Maker are used. A user may use the Back 918 and Next 919 buttons to go back to the Select stage or advance to the Tune stage. However, a user is not able to advance past the Configure stage until all required information is provided. If any information is missing, the Play Selector will display a warning at the bottom.

An example of the interface for the Tune stage of the Play Selector is shown in FIG. 10. The panels at the top and the left are the same as shown for the Configure Stage. The main panel contains an example Play Checklist that provides the user with a checklist of all tasks and subplays (1006, 1008, 1010, 1012, 1014, 1020, 1024, and 1026) utilized in the entire play. This checklist may include both items from the node graph from the previous stage as well as any additional items defined by the user in the Play Maker. The checklist may also indicate which tasks are the responsibility of the human and which are the responsibility of the HAT system FIG. 19 agent with an icon at the front of each item. Tasks assigned to the human may be represented by a user icon and agent tasks with a robot icon in the UI. Tasks that may require an ALTA interaction between both the agent and the human operator may be indicated with a hybrid human-robot icon. For checklist items that may result in such an interaction, the user can override ALTA, for example by using the drop-down menu to the right of the item, such as 1016 and 1018, in the UI. Selecting a level of automation from this menu will set the maximum level of automation that can be employed by the agent for the corresponding checklist item. Tasks and subplays that include nested tasks and subplays are indicated as indented items, as shown in Analyze Delay Options 1014.

An example of the interface for the Confirm stage of the Play Selector is shown in FIG. 11. The panel at the top is the same as shown in the Configure and Tune Stages. The main panel contains a high-level summary of projected actions that will occur once the play is initialized 1102 and 1104. The panel also includes the list of assets that will be involved 1106 and 1108, and the input parameters provided to the Play Selector for the play 1110-1120. Once a user clicks on the “Next” button 1122 in the lower right, the play will begin and it will be added to the list of active plays in the Play Manager. Additionally, the Play Conductor display (described below) will update to reflect the newly executed play.

Play Manager Examples

In some example embodiments, the Play Manager may occupy the top portion of the main HAT interface as shown in FIG. 12. In some examples, along with the Play Conductor, the Play Manager may be one of the two major components of the Play Interface. Displayed in the Play Manger may be a searchable list of active plays (“Active Plays”) 1202, actions requiring the operator's attention (“Actions”) 1208, a toggle-able history panel (toggled by clicking the button labeled “History”) 1210, and a button to invoke the Play Selector for executing new plays (“Add Play”) 1206. By clicking on the corresponding column header in the Active Plays list UI, currently running plays can be sorted by play name 1212, status 1214, and number of actions requiring user attention 1216.

The Actions panel 1208 shows a list of actions requiring user attention for all actively running plays 1218 and 1220. In this context, “actions requiring user attention” are those whereby an evaluation for ALTA in a sub-play determined that the LOA for the action falls below the autonomous execution level. Consequently, list items may be generated for actions at the veto, select, or manual levels of automation. Each action item shows the aircraft callsign, the type of alert, the action's “age” (i.e., the length of time that the card has been awaiting human attention), the action's determined LOA, and a brief description of the automation's recommendation when possible. The LOA is represented both by color and by icon: veto-level actions have a green, circular icon showing a clock/timer; select-level actions have an amber, diamond-shaped icon showing an ellipsis; and manual-level actions have a red, triangular icon showing an exclamation point. As in such examples that do not require human approval, actions that are autonomously executed by the HAT system FIG. 19 do not have a corresponding list item, though autonomous executions are recorded and viewable in the toggle-able history pane. Veto-level actions will show the veto timer (e.g. item 1220) indicating the time remaining until autonomous execution without human intervention.

In some examples, when selected, a blue background or other UI feature, may appear behind the action item in the Actions panel. Also, in some examples, selection of any item in the Actions pane will also change the context of the play conductor to provide more details about suggested actions for the corresponding aircraft and play. FIG. 13 illustrates this for selected veto-level actions, where an operator may choose to immediately execute an action, veto an action, or just wait for autonomous execution. Here two buttons 1304 and 1306 may be provided to either execute the suggested action or veto the suggestion, thus halting/canceling the veto timer. In such examples, if a veto-level action is vetoed, the action will be dropped down to the select level. Select level actions, whether determined to be at the select level by ALTA or as a result of a veto, will have a button to execute the suggested action. Actions determined to be at the manual LOA do not have a button to execute a suggested action, as these actions are only generated if ALTA determines all evaluation criteria to be below the least acceptable level per the ALTA schedule. Once an action has been executed (including autonomous executions if a veto timer expires) that associated list item is removed from the Actions pane and will appear under the toggle-able history pane.

Play Conductor Examples

In some examples, the Play Conductor may provide the operator with detailed information about a currently selected, active play as shown for example in FIG. 14. Such UI feature may be located on a screen below the Play Manager in the main HAT system FIG. 19 interface and consists of two major components: the play node graph (top), and the aircraft status and recommendation pane (bottom). The node graph 1400-1408 contains all the information in the node graph displayed in the Play Maker and Configure display of the Play Selector with some additions allowing it to show how aircraft are progressing through the play. The status and recommendation pane contains a list of the aircraft involved in the selected play 1410, 1412 and 1414, more detailed status information about any aircraft selected from that list 1410, and detailed information and options related to suggested actions for the aircraft selected in the aircraft list 1416-1434. This section will elaborate on these components in detail for the case of a “Divert 2 Play” which seeks routes to alternate airports.

In addition to providing a bird's eye view of the selected play's structure, the node graph of the play conductor provides added information about the status of aircraft within the play. As aircraft move through subsequent stages of the play, their corresponding call signs are shown beneath the nodes at which aircraft currently reside. In the example shown, when an action exists for the associated aircraft, call signs are shown together with priority iconography matching that used in the Actions pane of the Play Manager. As an example, the node graph of the Divert 2 Play (FIG. 14), NASA11, NASA13, and NASA12 have veto-, select-, and manual-level actions associated with them, respectively.

In some UI examples, it may be possible to undock the node graph by clicking on a button in the top right hand corner of the node graph to move it to another monitor, which is especially useful for landscape displays.

In the example shown, the Aircraft List displays the aircraft involved in the currently selected play in the Play Manager, along with their destination and a route score that shows the relative quality of their current route. The order of the aircraft in the list may be sorted using a drop-down menu 1413 above the Aircraft List. Options for sorting the aircraft are by call sign, priority, and estimated-time-to-arrival. If an aircraft has a pending action associated with it, the iconography used for the priority of the action appears to the left of the call sign using the same scheme as in the Actions pane and node graph of the Play Conductor. An additional icon depicting a circled checkmark will appear in the aircraft list to indicate that an aircraft has completed the play. An aircraft that has completed the play can be acknowledged and “dismissed” from the list by selecting it in the Aircraft List and clicking on an X in the upper right of its entry. To the right of the Aircraft List additional information about a currently selected aircraft is provided 1410 that may contain suggested actions, extended status or, in the case that an aircraft has completed the play, information about an action that has taken place.

The R-HATS interface may integrate with the rest of the TSD and ACL of the greater RCO ground station. As such, changing selections, for example ownship, in a play's Aircraft List will automatically make the corresponding changes on the TSD and ACL. In the event that a user would like to perform selections in R-HATS or the rest of the ground station independently of each other, the Aircraft List can be toggled between linked and unlinked states. In a UI example, this function is toggled by a button located in the upper right of the Aircraft List. When shown in the linked state (chain link icon), the full ground station will change selections in concert. When toggled in the unlinked state (broken chain icon), users may make selections independently.

The actions recommendation portion of the recommendation and status pane of the Play Conductor provides the greatest level of detail about suggested actions for the aircraft selected in the Aircraft List 1414. As pictured in FIG. 14, divert options 1424 returned from an external candidate problem resolver (214 in FIG. 2) are shown for an aircraft, NASA16. As pictured, ALTA has evaluated this aircraft's current situation to be at the Select level of automation, thus presenting a recommended option plus other options rated W, and requiring the operator to select from these or develop and alternative. In this case, a message is displayed 1410 indicating the need for user approval of the recommended route. Beneath the message is a short summary of the action that is awaiting approval (“Route waiting approval: KBOI 10R”) and a time-stamped (in Zulu time) event history for NASA16. To the right of the message is a computed checklist 1416 of all user and agent tasks and actions in the play. Human and robot icons appear beside checklist items to designate whether the item is the responsibility of the agent (i.e., autonomous LOA) or of the human operator (i.e., select or manual LOA). In the case that a checklist item is evaluated to be at the veto LOA (and has not yet been vetoed or executed by the user), a combination of the human and robot icon are shown. This is to designate that the action may be executed by either the human or the automation, the latter occurring if the operator does not intervene. In a fashion similar to the previously described checklists of the Tune stage of the Play Selector wizard, the operator has the ability to override ALTA using dropdown menus beside relevant items on a checklist that utilize ALTA. By overriding ALTA, the operator specifies the maximum allowable LOA for the action in the checklist.

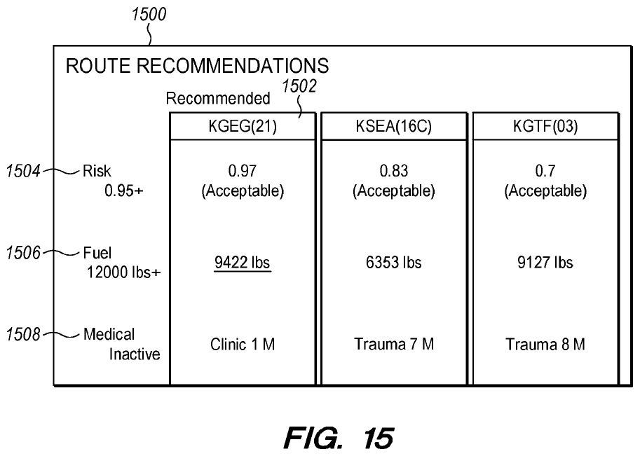

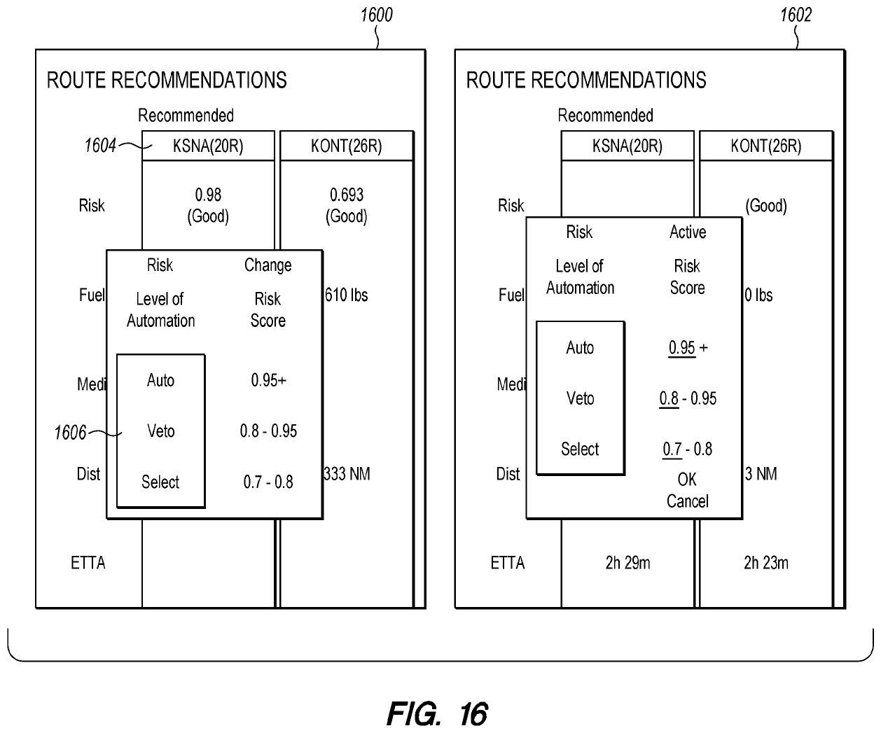

In the example the Route Recommendations table (1424) shows route options provided by the candidate problem resolver. FIG. 15 shows another example of this table. Each option is evaluated as previously described in the initial sections of this document. That is, the LOAs associated with Predicted Candidate Resolution States Evaluations (414 in FIG. 4) are initially determined for each of the criteria for each route recommendation. In some examples, this LOA can be viewed by the operator by hovering the cursor over a criterion for a particular recommendation—a colored bar along with the associated LOA icon appears if the criterion is active and was factored into the ALTA calculation. Not all criteria are necessarily used in making recommendations, such as the Medical criterion in FIG. 15. Next, an Overall LOA is determined for each route recommendation, based on the criterion with the lowest LOA. For example, if a route recommendation is based on the LOAs associated with three criteria, and these yield values of Auto, Veto, and Select levels of automation, the Overall LOA would be Select. The Overall LOA is then used to sort the route recommendations with the higher LOA recommendations being placed to the left of the lower ones. Finally, options are sorted, left to right, with the highest Overall LOA options to the left and the lowest LOA options to the right. If there are multiple options with the same Overall LOA, an arbitrary method may be employed to sort within the Overall LOA category. This is the case with FIG. 15, where all options share the same LOA (‘Select’). In any case, the leftmost option may be presented and labeled as the Recommended option, 1502 in this example. The columns to the right of this option provide alternate divert options. The rows of the table provide relevant criteria for ALTA to consider for evaluating diversion. The current setting for the highest ALTA threshold is provided beneath each criterion category. When a given dimension is clicked, a tool tip is displayed showing the ALTA thresholds used for that dimension as shown in FIG. 16. By clicking a “Change” button on this tool tip, a user can modify the threshold values or remove the dimension altogether from ALTA consideration by toggling the “Active”/“Inactive” button. However, it should be noted that any changes made to these thresholds will not take effect until the “Refresh” button is clicked on the right.

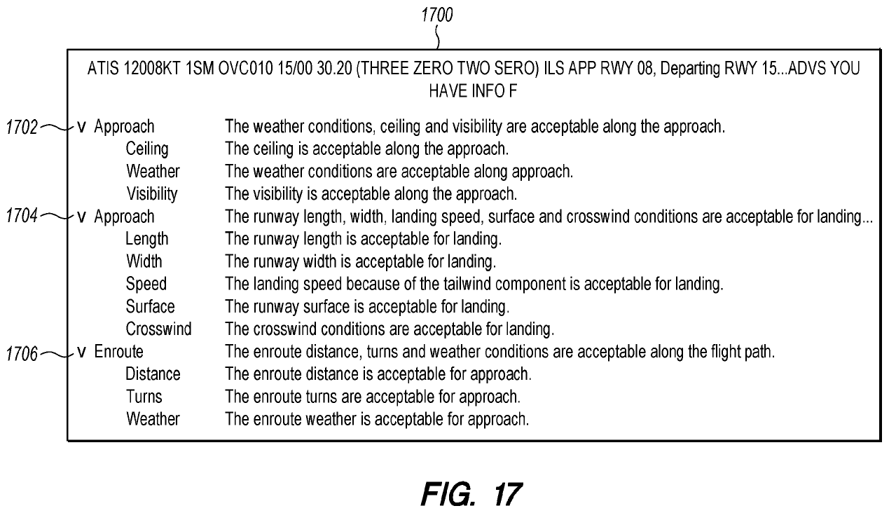

The operator may select a recommendation by clicking on a column in the recommendation table. A selected column of the recommendations table may be indicated in some examples with a blue header showing the recommended diversion airport and runway, but could be any UI indicator. A drill down menu below the table (1428-1430 in FIG. 14) may provide additional transparency information for the selected option. For the divert option this menu may provide information regarding the enroute, approach, and landing phases of the suggestion diversion in addition to the ATIS information for the destination airport of the selected option. Qualitative evaluations of these are provided along with color-coded text to indicate risk levels. These divert option evaluations may be computed as composites of normalized scores for risk factors within the enroute, approach, and landing phases of flight. A list of categories that may be used to provide transparency for the divert options is shown in FIG. 17 and in Table 3 below; Table 4 provides the correspondence between normalized factor scores, their qualitative description, and their displayed color. The explicit value of the normalized score for each factor is not shown to the user, but instead is provided by a visual bar colored using the same scheme defined in Table 3.

TABLE 3
Phases of flight and their corresponding risk factors

| Phase | Risk Factors |
|---|---|
| Enroute | Distance, turns, weather |
| Approach | Ceiling, weather, visibility |
| Runway | Length, wind, speed, surface, crosswind |

TABLE 4
Mappings between candidate problem resolver risk
factor scores and descriptor/color combinations.

| Score Range | Description/Text Color |
|---|---|
| 0.61-1.0 | Acceptable/Green |
| 0.21-0.60 | Marginal/Amber |
| 0.00-0.20 | Unacceptable/Red |

Example Application to Landfills

The human autonomy teaming system described above has broad applications in which the human autonomy teaming system facilitates teamwork and interaction between the human user/operator and enables the whole team, both human and automation, to perform complex tasks.

An example application is an environmental monitoring system, which collects and provides visualization of landfill odor/gas data in real time, and converts this data into actionable information for policy making and operational improvements. The result is to allow a single operator (or a few operators) to manage multiple aerial and/or ground drones, thereby achieving a justifiable economy of scale without overloading the operator(s).

Example drone fleet embodiments may be configured collect and visualize landfill odor/gas data in real time, and to convert this data into actionable information for policy making and operational improvements. Examples may include a network of unmanned ground and aerial drones that operate semi-autonomously, that is with minimal human oversight, utilizing a suite of sensors on the drones that collect and transmit the odor/gas data wirelessly, a 4D (3D spatial and time) interface for visualizing the network of drones and sensor data, and a real-time data management and analysis system. In some examples, for a single landfill site, six or more vehicles may be in simultaneous operation, with the possibility of an operator handling more than one site. In some examples, the number of drones may be more or less than six, which is not intended to be limiting.

Alerts may be generated by the drones themselves, when or shortly after sensor data is generated onboard. In some examples, alerts may be generated at a back-end system when sensor data is received from one or multiple sensors and/or drones. Such consolidated sensor data may be processed and compared against a set of standards or thresholds to determine any number of alert parameters.

Such automated or semi-automated drone fleets may deliver actionable data tied to regulatory standards enabling quicker and better informed decisions—in contrast to the limited data collected manually by an inspector and delays in processing and identifying actions needed to address leaks and other issues. Drone fleets may also provide for easier and faster validating of decision efficacy, allowing operators/enforcement agencies to check for the effectiveness of the solutions in a timelier manner than the current practice. Drone fleets may save time and money with better remediation response and outcomes, which is made possible by the fact that such drone fleets may be able to generate more data both in terms of quality and quantity. These fleets may also enable inspectors to find and address leaks faster, thus reducing financial losses as well as reducing greenhouse emissions.

Such example systems and methods here consist of a human autonomy teaming system, automation (e.g., navigation, control, and communication) that executes mission tasks, a network of unmanned ground and aerial drones that operate semi-autonomously, that is with minimal human oversight, utilizing a suite of sensors on the drones that collect and transmit the odor/gas data wirelessly, a 4D (3D spatial and time) interface for visualizing the network of drones and sensor data, and a real-time data management and analysis system. Collectively, the systems and methods here may provide these capabilities for landfill management, such as but not limited to:

Monitoring odors/gases and generating real-time analyses and alerts 24 hr/day, 7 days/week, in contrast to the existing practice of monthly inspections;

Providing a scalable number of rovers/drones, which allow significantly more data collection than the existing practice of having an inspector walk the landfill once a month and manually measure and analyze emissions;

Delivering actionable data tied to regulatory standards enabling quicker and better informed decisions—in contrast to the limited data collected manually by an inspector and delays in processing and identifying actions needed to address leaks and other issues;

Easier and faster validating of decision efficacy, allowing operators/enforcement agencies to check for the effectiveness of the solutions in a timelier manner than the current practice

Saving time and money with better remediation response and outcomes, which is made possible by the systems and methods here which are able to generate more data.

Enabling inspectors to find and address leaks faster, thus reducing financial losses as well as reducing greenhouse emissions.

The HAT system leverages the respective strengths of the human operator, whose role can be that of a mission planner and a real-time operational supervisor a consumer of information, and the automation, which directly executes planned activities. The HAT system may help manage the automation, and perform system supervision, emulating a human-style interaction. In some examples, the HAT system manages the information to be presented on the displays, while at others it will present issues, problems or decisions that need to be made, along with options, to the operator, actively participating in collaborative decision making. It may be configured to perform these functions during both the active mission, and during pre-mission planning. The HAT system supports pre-mission planning, and dynamic mission and contingency management, by providing the following human autonomy teaming capabilities:

Helping with pre-mission planning, and mission and contingency management.

Providing interactive visualizations that help operators more easily understand and manage their tasks.

Helping to collaboratively and dynamically allocate roles and responsibilities based on nature of the operation, quality of automation determined solutions, and operator status (workload, fatigue, etc.)

Additionally, the HAT system incorporates the following goals/capabilities in its human-automation teaming environment:

The ability to catch and address human mistakes. For example, software that uses criteria similar to that used by the ALTA agent could be employed to assess if human inputs are likely to result in some adverse state. Then, depending on how adverse the outcome will be, and how soon it will happen, the software could take different actions. In one case it might immediately reverse a pilot's input if there was a very high and immediate risk of a very severe outcome (e.g., hitting another aircraft within 5 seconds), and then advise the pilot of what it did and why. In another case it might just advise the pilot if the consequence of an input was less severe but still above a certain threshold (an encounter with mild clear air turbulence); or if there was time for the pilot to address a sufficiently future consequence, e.g., where the pilot began a descent toward the ground that would impact the ground in 2 minutes.

The capability to take the initiative in offering suggestions, pointing out hazards and threats, and asking for help when needed.

The ability to engage in bi-directional (human-automation) communications and joint decision-making, primarily through use of multi-modal interfaces that employ voice recognition and synthesis.

Fostering appropriate trust in automation, primarily by use of technology which promotes transparency (e.g. rationale behind automation derived risk assessments and levels).

As shown again in FIG. 1, the systems and methods here may include the human-autonomy teaming, tools, displays and software that leverages the respective strengths of the human and the automation, facilitates their teamwork, enables human-style interaction during collaborative decision making, tailors automation to the individual human and, ultimately, allows a single operator to manage multiple aerial and ground drones.

FIG. 1 shows the fleet of drones 110, 112 or remote vehicles in communication with the back-end systems 102 through wireless communication. Also depicted is an interface with a human operator(s) 102 as well as a ground control station 120. In some example embodiments, for security reason, data may be passed back and forth between the vehicles and the cloud (i.e., the back end), and between the ground control station and the cloud. In such examples, the cloud may serve as the intermediary between the vehicles and the ground control station.

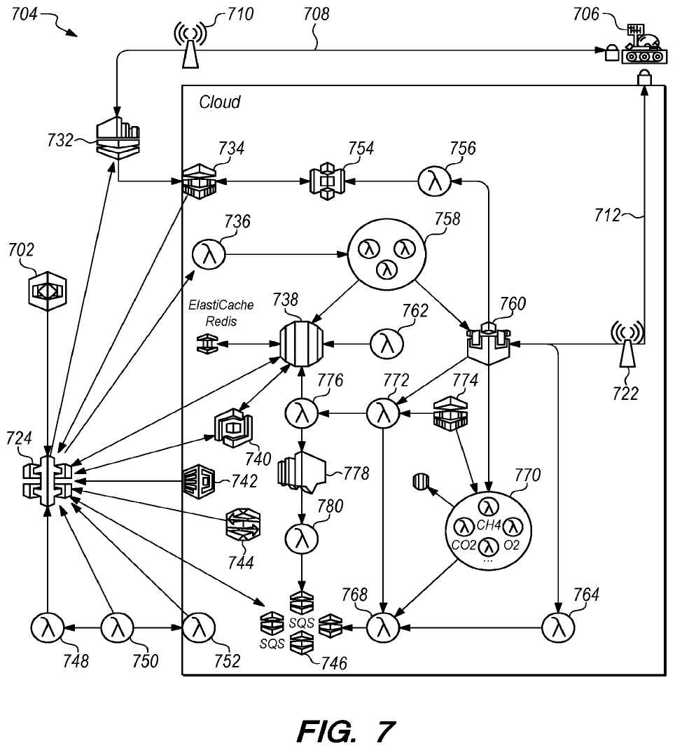

An example embodiment of a design architecture of the networked drone fleet and back end systems is shown in FIG. 7. In the example, three main components, the software application 702, the distributed database/processing cloud 704, and the vehicles or drones with sensors 706. The software application 702 may be used to digest data and interface with a human operator, or produce reports which may be analyzed, based on the data. The drone 706 depicted in FIG. 7 is representative of any number of drones in any configuration. The data 708 sent from these drone fleets may be received wirelessly by any number of antennae 710 through any kind of wireless system described herein.

The remote vehicles or drones 110, 112 could be equipped with any number of sensors and be capable of any kind of locomotion as described herein. The back end system 102 could be a distributed computing environment that ties together many multiple features and capabilities such as but not limited to vehicle health monitoring which may be used to monitor the vehicles 110, 112 status, such as battery life, altitude, damage, position, etc. In some examples, the back end system 102 may include the ability to utilized predictive analysis based on prior data to contribute to a risk analysis and even ongoing risk assessments of the vehicles in the field. The back end 102 in some examples may also be able to generate and communicate alerts and notifications such as sensor threshold crossings, vehicle health emergencies, or loss of coverage situations.

In some examples, the ground station control 120 may be a system which is configured to monitor the locations of the vehicles 112, interface with human operator(s) and interface for Plays as described herein.

The described Automation Level-Based Allocation (ALTA) algorithm is being used for managing level-of-automation (LOA) and providing teamwork between the automation and the operator in ways that keep the operator workload manageable while managing multiple drones for landfill operations. The goal is to provide a teaming approach where the automation can take on more of the routine responsibilities while leaving the operator in ultimate control. This is valuable in situations where the operator may be overloaded (e.g., a UGV en-route to a monitoring location needs to re-route around a geofenced region that has just popped up to protect human activity while at the same time the operator must prepare an urgent mission to check out a reported landfill fire); or when the solution to a problem is so simple and obvious that there is no reason to bother the operator (e.g. bringing a UAV back to base because its monitoring equipment is malfunctioning). LOA, the degree to which human-versus-automation involvement is required, spans autonomous decisions and executions (no human involvement) through fully manual operation (no role for automation). ALTA provides contextually aware dynamic LOA determinations. Dynamic LOA determination refers to adjusting the LOA in response to how well, relative to operator determined criteria, the automation is able to handle that task. For the HAT system, ALTA will aid the operator by determining the degree to which tasks, such as selecting a risk mitigation response, can be shared with the automation. The human operator is given the responsibility for adjusting the criteria which ALTA uses to determine LOA. ALTA can be applied to any number of measures of optimal operations, but risk is a primary measure. As a part of the HAT system, our implementation assumes an outside risk assessment program, a monitoring routine which will detect a risk, and a set of candidate solutions or actions that can be evaluated with that risk assessment program. In some example embodiments the steps in the implementation may be:

Automated or human detection of sub-optimal (risky) operational states (the Problem)

Automated or human generation of candidate actions (risk mitigations) designed to yield new states (Solutions) that resolve the Problem.

Ordinal level measurements (Evaluations) of the quality (risk and mission success) of these Solutions.

Use of threshold values that, together with these Evaluations, partition Solutions into categories corresponding to acceptable levels of automation (LOA).

Selection of LOA based on LOA category of Solution with highest Evaluation (acceptable risk and mission success))

Execution of actions dictated by the selected LOA

A play-based mission planning and control technology can be integrated into the HAT system to enhance the capabilities of the operator of the HAT system to quickly place a coordinated risk management plan in motion, monitor mission progress during play execution, and fine-tune mission elements dynamically as the play unfolds.

The HAT system will be an independent module capable of being integrated into a ground control station. The code base is in the C# language. The systems and methods here may employ distributed compute and/or internet services for things such as cloud computing for data processing, compression, and storage; Internet of Things (i.e., network of physical devices such as vehicles and appliances embedded with electronics, software, sensors, actuators, and connectivity which enables these devices to connect and exchange data) for data transmission via internet devices (e.g., satellites, fourth-generation long term evolution (LTE) internet); artificial intelligence for pattern/image recognition; and conversational user interfaces with natural language understanding. The systems and methods here may be designed to be scalable and flexible with respect to the number of sensors, vehicles, users, and monitoring sites.

An example design for the architecture of the systems and methods here are shown in FIG. 7. It consists of three main components, the application, the distributed compute resources or cloud based computing resources, and the vehicles. The architecture is designed with a strong focus on scalability, security, and extensibility in order to handle data from a large number of vehicles and communicate with diverse stakeholders. This is achieved through a plugin-based system and the utility of distributed compute resources such as Lambda (a serverless event-based service that runs code according to event triggers), Relational Database Service (RDS, a cost-efficient and resizable capacity service that sets up, operates, and scales relational databases in the cloud), API Gateway (a fully managed service that allows developers to create, publish, maintain, monitor, and secure APIs at any scale), and Internet of Things that connect physical world to the internet. Together, these services provide support for features such as user access control, data management, notifications, vehicle commands, vehicle monitoring, route generation and evaluation, image processing, and conversational user interfaces. All data is transferred securely using SSL encryption through the API Gateway service that provides, among other things, a front-end for accessing various distributed compute resources, retrieving data stored in the cloud, and launching Lambda functions.

In terms of information flow, the systems and methods here may first authenticate each user through distributed compute resources such as Cognito to determine the permission levels and sync user preferences. After authentication, the systems and methods here may pull relevant data from RDS SQL server for vehicle and sensor data visualization. This data is constantly updated by vehicles, sensors, and other IoT devices using distributed compute IoT and Lambda functions. In addition to vehicle information updates, Lambda functions are responsible for monitoring vehicle health, logging and storing data, monitoring sensor thresholds based on user-specified constraints, and triggering notifications or events. Since each Lambda function is invoked only when necessary and starts as a new instance, the amount of data processed or the number of vehicles monitored is infinitely scalable. Lambdas can also trigger services like Machine Learning to enable enhanced monitoring and trend identification of odors data and gas emission. In addition to Machine Learning, the systems and methods here have architecture that may incorporate other AI-powered services from distributed compute such as Rekognition for performing continuous analysis and image processing on real-time photos or video streams taken on the landfill to detect the presence of gas leak (e.g., based on the signature of the cracks on the ground's surface) or leachate (liquid that liquid that drains or ‘leaches’ from a landfill that can produce strong foul odors and cause pollution) and Polly and Lex (commonly used in talking devices) for providing support for natural conversational user interfaces.

FIG. 7 shows a more detailed beak down and concentrates on the back-end system 704 which operates to receive, analyze, interpret, and communicate to both the drone fleet 706 by a wireless secure method 712, through any kind of antennae 722 different or the same as the receiving data 710.

The back-end system 704 could be hosted on any number of hardware systems including but not limited to a server, multiple servers, distributed server arrangement, cloud-based arrangement, or any number of remote, distributed, or otherwise coordinate server systems. These could be located in any physical location, and communicate with the application 702 and/or the drone fleet 706 wherever in the world they are located.

In the back-end system 704, an API gateway 724 allows communication and coordination of data flowing to the application 702. This API gateway coordinates data from many different sources, in certain examples, additionally or alternatively with an image recognition segment 730, a kinesis stream segment 732, a machine learning sagemaker deeplens segment 734, vehicle command distributer segment 736, database segment 738, Authentication segment 740, an application that turns text into speech such as a text-to-speech service Polly 742, lexicography comprehend engine segment 744, SQS message queuing service segment 746, as well as segments such as impact projection 748, risk assessment 750 and route generation 752. It should be noted that a kinesis stream is not limited to being an image processing service. It may be an AWS service for transferring large amounts of data quickly.

In some examples, the machine learning segment 734 may exchange data with a machine learning data segment 754 which in turn communicates with an internet of things (i.e., network of physical devices such as vehicles and appliances embedded with electronics, software, sensors, actuators, and connectivity which enables these things to connect and exchange data on the internet through wireless communication standards such as Wi-Fi or 4G LTE) engine segment 760. In some examples, the machine learning data segment 754 would handle where the data is coming from.

In some examples, specific vehicle commands 758 receive data from the vehicle command distributer segment 736 and send data to the IoT engine segment 760 as well as the database segment 738.

In some examples, the IoT engine segment 760 may send data regarding data update and logging 762 to the database segment 738.

In some examples, vehicle data change notifications 764 are sent and received from the IoT engine segment 760 and send online user access check data 768 to the SQS message queuing service segment 746. In some example embodiments, this online user access check data 768 may also be sent from the specific sensor health monitors 770. Vehicle health monitoring 772 may also be sent to a save notification 776 to the database segment 738.

In some examples, a simple notification service segment 778 may send the save notification data 776 to the database 738 segment and send data to distribute to online users 780 to the SQS message queuing service segment 746.

The architecture is designed for scalability, security, and extensibility in order to handle data from a large number of vehicles 706 and communicate with diverse stakeholders by way of the application 702 and message segments 746. In some examples, this may be achieved through a plugin-based system and the utility of distributed databases, Relational Database Service (RDS, a cost-efficient and resizable capacity service that sets up, operates, and scales relational databases in the cloud), Application Program Interfaces (API) Gateway 724 (a fully managed service that allows developers to create, publish, maintain, monitor, and secure APIs at any scale) 710, and Internet of Things engine 760 that connects devices (e.g., vehicles) in the physical world to the internet via Wi-Fi or LTE.

Together, these services provide support for features such as user access control, data management, notifications, vehicle commands 736, vehicle monitoring 770, route generation 752 and evaluation 750, image processing 730, and conversational user interfaces 744.

In some examples, additionally or alternatively, the network may transfer data securely using SSL encryption through the API Gateway service that provides, among other things, a front end for accessing various distributed computer resources, retrieving data stored in the cloud, and launching Lambda functions.

In certain examples, Users may interface with the systems and methods here in various ways. In some examples, systems and methods here may first authenticate each user through distributed computing services such as but not limited to Cognito, which is a user authentication management service developed by Amazon Web Services that determines the permission levels and sync user preferences. After authentication, the systems may pull relevant data from RDS SQL server for vehicle and sensor data visualization in a UI. This data may be constantly updated by vehicles, sensors, and other IoT devices using distributed computing services IoT and anonymous or Lambda functions. In addition to vehicle information updates, Lambda functions may be responsible for monitoring vehicle health, logging and storing data, monitoring sensor thresholds based on user-specified constraints, and triggering notifications or events. Since each Lambda function may be invoked only when necessary and start as a new instance, the amount of data processed or the number of vehicles monitored is infinitely scalable. Lambdas may also trigger services like Machine Learning to enable enhanced monitoring and trend identification of odors data and gas emissions.

In addition to Machine Learning, the disclosed architecture incorporates other AI-powered services from distributed computing services such as a system for performing continuous analysis and image processing on real-time photos or video streams taken on the landfill to detect the presence of gas leaks (e.g., based on the signature of the cracks on the ground's surface) or leachate (liquid that drains or ‘leaches’ from a landfill that can produce strong foul odors and cause pollution) and Polly and Lex (used in voice activated talking devices) for providing support for natural conversational user interfaces. In some examples, the service may be one such as, but not limited to, Rekognition.

Example Computing Devices

In some examples, the system may house the hardware electronics that run any number of various sensors and communications, as well as the sensors themselves, or portions of sensors. In some examples, the drone bodies may house the sensors or portions of sensor systems. In some examples, sensors may be configured on robotic arms, on peripheral extremities or other umbilical's to effectively position the sensors. In some examples, the drone bodies may include wireless communication systems which may be in communication with a back-end system that can intake and process the data from the sensors and other various components on the drones. Various modes of locomotion may be utilized such as but not limited to motors to turn wheels, motors to turn rotors or props, motors to turn control surfaces, motors to actuate arms or peripheral extremities. Example power supplies in such systems may include but are not limited to lithium-ion batteries, nickel-cadmium batteries, or other kinds of batteries. In some examples, alternatively or additionally, a communications suite such as a Wi-Fi module with an antenna and a processor and memory as described herein, Bluetooth low energy, cellular tower system, or any other communications system may be utilized as described herein. In some examples, navigation systems including ring laser gyros, global positioning systems (GPS), radio triangulation systems, inertial navigation systems, turn and slip sensors, air speed indicators, land speed indicators, altimeters, laser altimeters, radar altimeters, may be utilized to gather data. In some examples, cameras such as optical cameras, low light cameras, infra-red cameras, or other cameras may be utilized to gather data. In some examples, point-to-point radio transmitters may be utilized for inter-drone communications. In some embodiments, alternatively or additionally, the hardware may include a single integrated circuit containing a processor core, memory, and programmable input/output peripherals. Such systems may be in communication with a central processing unit to coordinate movement, sensor data flow from collection to communication, and power utilization.

FIG. 8 shows an example computing device 800 that may be used in practicing certain example embodiments described herein. Such computing device 800 may be the back-end server systems use to interface with the network, receive and analyze data, including sensor data, as well as coordinate GUIs for operators. Such computer 800 may be a server, set of servers, networked or remote servers, set to receive data, as well as coordinate data and display GUIs representing data. In FIG. 8, the computing device could be a server computer, smartphone, a laptop, tablet, or any other kind of computing device. The example shows a processor CPU 810 which could be any number of processors in communication via a bus 812 or other communication with a user interface 814. The user interface 814 could include any number of display devices 818 such as a screen. The user interface also includes an input such as a touchscreen, keyboard, mouse, pointer, buttons or other input devices. Also included is a network interface 820 which may be used to interface with any wireless or wired network in order to transmit and receive data to and from individual drones and/or relay stations. Such an interface may allow for interfacing with a cellular network and/or Wi-Fi network and thereby the Internet. The example computing device 800 also shows peripherals 824 which could include any number of other additional features such as but not limited to sensors 825, and/or antennae 826 for communicating wirelessly such as over cellular, Wi-Fi, NFC, Bluetooth, infrared, or any combination of these or other wireless communications. These could be operable on a drone or connected to the back-end itself. The computing device 800 also includes a memory 822 which includes any number of operations executable by the processor 810. The memory in FIG. 8 shows an operating system 832, network communication module 834, instructions for other tasks 838 and applications 838 such as send/receive message data 840 and/or sensor data 842. Also included in the example is for data storage 858. Such data storage may include data tables 860, transaction logs 862, sensor data 864 and/or encryption data 870.

### CONCLUSION

As disclosed herein, features consistent with the present inventions may be implemented by computer-hardware, software and/or firmware. For example, the systems and methods disclosed herein may be embodied in various forms including, for example, a data processor, such as a computer that also includes a database, digital electronic circuitry, firmware, software, computer networks, servers, or in combinations of them. Further, while some of the disclosed implementations describe specific hardware components, systems and methods consistent with the innovations herein may be implemented with any combination of hardware, software and/or firmware. Moreover, the above-noted features and other aspects and principles of the innovations herein may be implemented in various environments. Such environments and related applications may be specially constructed for performing the various routines, processes and/or operations according to the invention or they may include a general-purpose computer or computing platform selectively activated or reconfigured by code to provide the necessary functionality. The processes disclosed herein are not inherently related to any particular computer, network, architecture, environment, or other apparatus, and may be implemented by a suitable combination of hardware, software, and/or firmware. For example, various general-purpose machines may be used with programs written in accordance with teachings of the invention, or it may be more convenient to construct a specialized apparatus or system to perform the required methods and techniques.

Aspects of the method and system described herein, such as the logic, may be implemented as functionality programmed into any of a variety of circuitry, including programmable logic devices (“PLDs”), such as field programmable gate arrays (“FPGAs”), programmable array logic (“PAL”) devices, electrically programmable logic and memory devices and standard cell-based devices, as well as application specific integrated circuits. Some other possibilities for implementing aspects include: memory devices, firmware, software, etc. Furthermore, aspects may be embodied in microprocessors having software-based circuit emulation, discrete logic (sequential and combinatorial), custom devices, fuzzy (neural) logic, quantum devices, and hybrids of any of the above device types.

It should also be noted that the various logic and/or functions disclosed herein may be enabled using any number of combinations of hardware, firmware, and/or as data and/or instructions embodied in various machine-readable or computer-readable media, in terms of their behavioral, register transfer, logic component, and/or other characteristics. Computer-readable media in which such formatted data and/or instructions may be embodied include, but are not limited to, non-volatile storage media in various forms (e.g., optical, magnetic or semiconductor storage media) and carrier waves that may be used to transfer such formatted data and/or instructions through wireless, optical, or wired signaling media or any combination thereof. Examples of transfers of such formatted data and/or instructions by carrier waves include, but are not limited to, transfers (uploads, downloads, e-mail, etc.) over the Internet and/or other computer networks by one or more data transfer protocols (e.g., HTTP, FTP, SMTP, and so on).

Unless the context clearly requires otherwise, throughout the description and the claims, the words “comprise,” “comprising,” and the like are to be construed in an inclusive sense as opposed to an exclusive or exhaustive sense; that is to say, in a sense of “including, but not limited to.” Words using the singular or plural number also include the plural or singular number respectively. Additionally, the words “herein,” “hereunder,” “above,” “below,” and words of similar import refer to this application as a whole and not to any particular portions of this application. When the word “or” is used in reference to a list of two or more items, that word covers all of the following interpretations of the word: any of the items in the list, all of the items in the list and any combination of the items in the list.

Although certain presently preferred implementations of the invention have been specifically described herein, it will be apparent to those skilled in the art to which the invention pertains that variations and modifications of the various implementations shown and described herein may be made without departing from the spirit and scope of the invention. Accordingly, it is intended that the invention be limited only to the extent required by the applicable rules of law.

The foregoing description, for purpose of explanation, has been described with reference to specific embodiments. However, the illustrative discussions above are not intended to be exhaustive or to limit the invention to the precise forms disclosed. Many modifications and variations are possible in view of the above teachings. The embodiments were chosen and described in order to best explain the principles of the invention and its practical applications, to thereby enable others skilled in the art to best utilize the invention and various embodiments with various modifications as are suited to the particular use contemplated.

The foregoing description, for purpose of explanation, has been described with reference to specific embodiments. However, the illustrative discussions above are not intended to be exhaustive or to limit the invention to the precise forms disclosed. Many modifications and variations are possible in view of the above teachings. The embodiments were chosen and described in order to best explain the principles of the invention and its practical applications, to thereby enable others skilled in the art to best utilize the invention and various embodiments with various modifications as are suited to the particular use contemplated. Etc.

What is claimed is:

1. A non-transitory computer-readable medium having computer-executable instructions thereon for a method of coordinating a plurality of remote drones, the method comprising:
analyzing input data to determine a system state of the plurality of drones, at a system state monitor;
sending system state variables to a problem detector,
wherein a problem is a variable outside a predetermined threshold;
if a new problem is detected by the problem detector, determining candidate resolutions at a candidate problem resolver using problem threshold data;
determining a level of automation for each of the determined candidate resolutions,
wherein the levels of automation are one of autonomous, veto, select, and manual;
sending resolutions and associated level of automation assignments for each of the remote drones to a resolution recommender; and
if the level of automation is autonomous, sending a top resolution as a command to each of the plurality of drones.

2. The non-transitory computer-readable medium of claim 1 wherein if the level of autonomy is veto, sending commands to each of the plurality of drones unless a veto is received from the user.

3. The non-transitory computer-readable medium of claim 1 wherein if the level of autonomy is select, sending manual selections for the user to select;
receiving one of the manual selections; and
sending the received manual selection to each of the plurality of drones.

4. The non-transitory computer-readable medium of claim 1 wherein if the level of autonomy is manual, waiting to receive manual input from the user;
receiving a manual input; and
sending the received manual input to each of the plurality of drones.

5. A method for coordinating a plurality of drones, the method comprising,
by a computer with a processor and a memory in communication with the plurality of drones,
by a candidate problem resolver, retrieving a candidate resolution from a data storage, and sending the retrieved candidate resolution to a candidate resolution states predictor;
by the candidate resolution states predictor, generating predicted candidate resolution states, based on the retrieved candidate resolution;
determining a level of autonomy governing the process of presentation for each candidate resolution;
selecting a top candidate resolution to execute from the a plurality of candidate resolutions;
determining the level of autonomy for the top candidate resolution; and
if the determined level of autonomy for the top candidate is autonomous, sending commands to each of the plurality of drones.

6. The method of claim 5 wherein if the level of autonomy is veto, sending commands to each of the plurality of drones unless a veto is received from the user.

7. The method of claim 6 wherein if the level of autonomy is select, sending manual selections for the user to select;
receiving one of the manual selections; and
sending the received manual selection to each of the plurality of drones.

8. The method of claim 7 wherein if the level of autonomy is manual, waiting to receive manual input from the user;
receiving a manual input; and
sending the received manual input to each of the plurality of drones.

9. The method of claim 5 further comprising an asynchronous problem resolver resolution manager configured to receive candidate resolutions with assigned levels of autonomy from an asynchronous problem resolver level of autonomy selector, and determining at least one of the following for the received candidate resolutions: identifying candidate resolutions sharing highest level of autonomy, breaking a tie, causing display of ordered recommendation list, causing display of a top candidate, sending a message for display to an operator that no acceptable candidate found by automation, and autonomously executing the top candidate.

10. The method of claim 5 further comprising receiving a play from the user, wherein a play allows a user to select, configure, tune, and confirm.

11. The method of claim 10 wherein select includes filter, search, and choose a play from a playlist.

12. The method of claim 10 wherein configure includes adding or removing assets and modifying thresholds.

13. The method of claim 10 wherein tune includes reviewing the play checklist, and changing the corresponding level of autonomy.

14. The method of claim 10 wherein confirm includes projecting actions that will occur after the play is initialized.

15. The method of claim 10 wherein a play includes nodes, and wherein each node includes inputs, tasks, and subplays.

16. The method of claim 10 wherein a node graph connects nodes to achieve the play.
